(19) United States
(12) Patent Application Publication
(10) Pub. No.: US 2022/0201177 A1
(43) Pub. Date: Jun. 23, 2022

(54) INFRARED IMAGING UNIT, IMAGING DEVICE, AND UNMANNED AERIAL VEHICLE

(71) Applicant: SZ DJI TECHNOLOGY CO., LTD., Shenzhen (CN)

(72) Inventors: Junli LIU, Shenzhen (CN); Jun DU, Shenzhen (CN); Yucheng LIU, Hangzhou (CN); Yong LIU, Hangzhou (CN)

(21) Appl. No.: 17/654,238

(22) Filed: Mar. 9, 2022

Related U.S. Application Data
(63) Continuation of application No. PCT/CN2020/109419, filed on Aug. 17, 2020.

(30) Foreign Application Priority Data
Sep. 10, 2019 (CN) 201921498105.9

(51) Int. Cl. H04N 5/225; H04N 5/33; G01J 5/061; B64C 39/02

(52) U.S. Cl. CPC H04N 5/22521; H04N 5/33; G01J 5/061; H04N 5/2252; G01J 2005/0077; G01J 2005/063; B64C 2201/123; B64C 2201/127; B64C 39/024

(57) ABSTRACT

An infrared imaging unit. The infrared imaging unit includes an infrared detector and a heat insulation assembly, the heat insulation assembly being disposed on one side of the infrared detector, the heat insulation assembly being used to isolate a heat transfer in the infrared imaging unit to the infrared detector.

### CROSS-REFERENCE TO RELATED APPLICATIONS

This application claims the priority of a Chinese patent application filed to the State Intellectual Property Office of China on Sep. 10, 2019 with the Application Number of 201921498105.9 and the invention titled “Imaging Device and unmanned Aerial Vehicle”, the entire content of which is incorporated herein by reference.

### TECHNICAL FIELD

The present disclosure relates to the technical field of infrared cameras and, more specifically, to an infrared imaging unit, an imaging device, and an unmanned aerial vehicle (UAV).

### BACKGROUND

With the development of UAV technology, thanks to the advantages of UAVs' high observation altitude and flexible flight, the use of UAVs to mount infrared cameras to perform reconnaissance, inspections, and other tasks are becoming more and more common, which has become a major development trend of the infrared detection industry. In related technologies infrared cameras can be directly mounted on UAVs to conduct thermal imaging surveys of the environment, and can be used for power line inspections, fire safety hazard investigations, and air support for firefighting work. However, when operating in the air, with only an infrared camera installed on the UAV, it is difficult for the UAV pilot to grasp the flight trajectory, and the observer cannot have an intuitive visual understanding of the observed object. In order to solve the above problems, in related technology, two cameras are mounted on the UAV at the same time, where a visible light camera is used with an infrared camera to collect more comprehensive information of the observed object. However, mounting two cameras on a UAV will lead to a relatively large payload on the UAV, which will significantly reduce the UAV's flight time. At the same time, two independent cameras mean higher maintenance and operating costs.

### SUMMARY

One aspect of the present disclosure provides an infrared imaging unit. The infrared imaging unit includes an infrared detector and a heat insulation assembly. The heat insulation assembly is disposed on one side of the infrared detector, and the heat insulation assembly is being used to isolate a heat transfer in the infrared imaging unit to the infrared detector.

Another aspect of the present disclosure provides an imaging device. The imaging device includes a visible light imaging unit and an infrared imaging unit. An infrared imaging unit lens and a visible light imaging unit lens face the same direction. The infrared imaging unit includes an infrared detector and a heat insulation assembly. The heat insulation assembly is disposed on one side of the infrared detector, and the heat insulation assembly is being used to isolate a heat transfer in the imaging device to the infrared detector.

Another aspect of the present disclosure provides a UAV. The UAV includes a body, a power device configured to provide power for the UAV, and an imaging device. The imaging device includes a visible light imaging unit and an infrared imaging unit. An infrared imaging unit lens and a visible light imaging unit lens face the same direction. The infrared imaging unit includes an infrared detector and a heat insulation assembly. The heat insulation assembly is disposed on one side of the infrared detector, and the heat insulation assembly is being used to isolate a heat transfer in the imaging device to the infrared detector.

### BRIEF DESCRIPTION OF THE DRAWINGS

The foregoing and/or additional aspects and advantages of this application will become more apparent and comprehensible with the description of the embodiments in combination with the accompanying drawings.

FIG. 1 is a schematic structural diagram of an imaging device according to an embodiment of the present disclosure.

FIG. 2 is another schematic structural diagram of the imaging device according to an embodiment of the present disclosure.

FIG. 3 is a schematic structural diagram of an infrared imaging unit of the imaging device according to an embodiment of the present disclosure.

FIG. 4 is an exploded view of the infrared imaging unit of the imaging device according to an embodiment of the present disclosure.

FIG. 5 is a partial schematic structural diagram of the imaging device according to an embodiment of the present disclosure.

FIG. 6 is another partial schematic structural diagram of the imaging device according to an embodiment of the present disclosure.

FIG. 7 is another schematic structural diagram of the infrared imaging unit of the imaging device according to an embodiment of the present disclosure.

FIG. 8 is a schematic partial cross-sectional view of the imaging device according to an embodiment of the present disclosure.

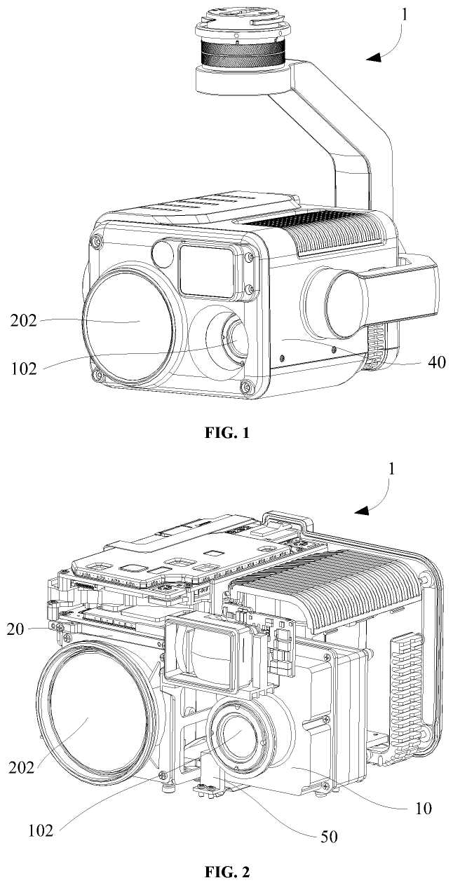

In some embodiments, the corresponding relationship between the reference numerals and component names in FIGS. 1-8 are:
1 Imaging device
10 Infrared imaging unit
102 Infrared imaging unit lens
104 Middle frame
106 Infrared detector
108 First heat insulator
110 Main circuit board
112 Signal processing circuit board
114 Second heat insulator
116 Heat conducting element
118 Front housing
120 Front housing heat conducting part
122 Middle frame heat conducting part
124 First sealing ring
126 Second sealing ring
128 Detector circuit board
130 Detector cover
132 Shutter
134 Flexible circuit board
136 Screw
138 Rubber ring
20 Visible light imaging unit
202 Visible light imaging unit lens
30 First temperature sensor
40 Housing
50 Second temperature sensor
60 Third temperature sensor

### DETAILED DESCRIPTION OF THE EMBODIMENTS

In order to allow more clear understanding of the objects, features and advantages of this application, the following further describes this application in detail with reference to accompanying drawings and specific embodiments. It should be noted that under a condition that no conflict occurs, the embodiments of this application and features in the embodiments may be combined with each other.

Many specific details are described in the following description for fully understanding this application. However, this application may be further implemented in other manners different from the one described herein. Therefore, the scope of protection of this application is not limited by the specific embodiments disclosed below.

Infrared imaging technology is a promising high-tech, which performing imaging by reflecting the surface temperature of an object. At present, this technology has been widely used in various application fields, such as power inspection, search and rescue, fire rescue, urban space modeling, etc. The present disclosure provides an infrared imaging unit, an imaging device, and a UAV. The infrared imaging unit may include an infrared detector and a heat insulation assembly. The heat insulation assembly may be disposed on one side of the infrared detector, such that the heat insulation assembly can isolate the heat in the infrared imaging unit from transferring to the infrared detector. Specifically, the heat insulation assembly can block the heat conduction and heat radiation of the heating parts in the infrared imaging unit to the infrared detector, and reduce the influence of the heat in the infrared imaging unit on the accuracy of the temperature measured by the infrared detector, such that the temperature measured by the infrared detector can be closer to the temperature of the measured object.

In the embodiments of the present disclosure, a UAV can be used to mount an infrared imaging unit or an imaging device to shoot scenes to obtain infrared images to realize the temperature measurement, target tracking and monitoring, etc. in UAV aerial photography or special scenes, thereby realizing the application in the above-mentioned application fields.

In some embodiments, not limited to UAVs, the infrared imaging unit, imaging device, or a device having infrared shooting functions may also be mounted on monitoring, detection, aerial photography devices, such as helicopters, surveillance cameras, robots, fire trucks, detectors, etc.

An infrared imaging unit 10, an imaging device 1, and a UAV provided in the embodiments of the present disclosure will be described below with reference to FIGS. 1-8.

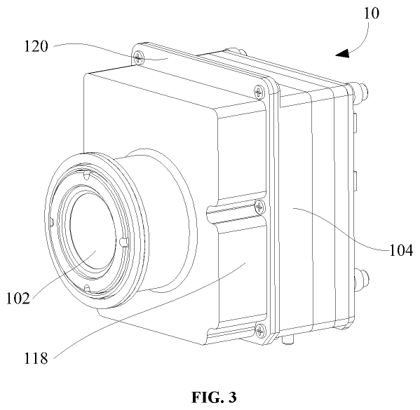

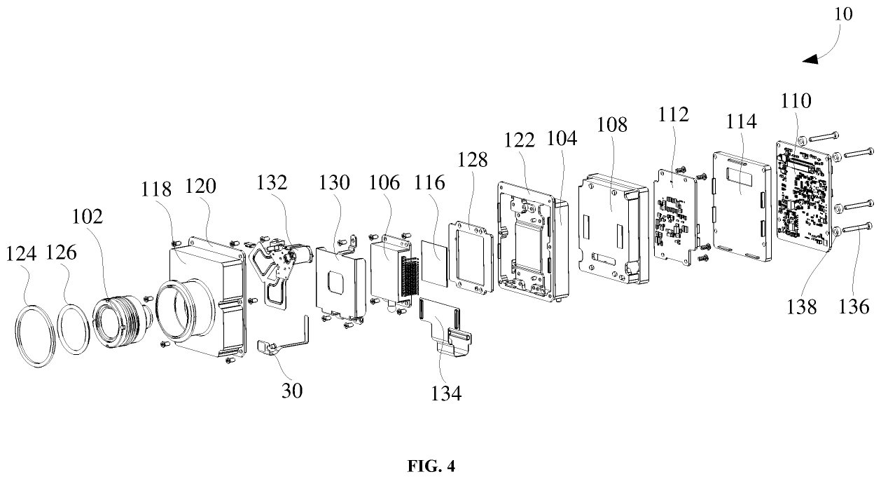

As shown in FIG. 3 and FIG. 4, the first aspect of the present disclosure provides an infrared imaging unit 10. The infrared imaging unit 10 includes an infrared detector 106 and a heat insulation assembly. The heat insulation assembly may be disposed on one side of the infrared detector 106. The heat insulation assembly can be used to isolate the transfer of heat in the infrared imaging unit 10 to the infrared detector 106.

The infrared imaging unit 10 provided in the present disclosure includes an infrared detector 106 and a heat insulation assembly. The heat insulation assembly may be disposed on one side of the infrared detector 106, such that the heat insulation assembly can isolate the heat in the infrared detector 106 from transferring to the infrared detector 106. Specifically, the heat insulation assembly can block the heat conduction and heat radiation of the heating parts in the infrared imaging unit 10 to the infrared detector 106, and reduce the influence of the heat in the infrared imaging unit 10 on the accuracy of the temperature measured by the infrared detector 106, such that the temperature measured by the infrared detector 106 can be closer to the temperature of the measured object.

As shown in FIG. 4 and FIG. 8, in one embodiment of the present disclosure, the infrared imaging unit 10 further includes a circuit board assembly, which is disposed on one side of the heat insulation assembly away from the infrared detector 106.

In this embodiment, the infrared imaging unit 10 includes a circuit board assembly, and infrared detector 106, and a heat insulation assembly. The circuit board assembly is disposed on the side of the heat insulation assembly away from the infrared detector 106. That is, the infrared detector 106 and the circuit board assembly are respectively disposed on both sides of the heat insulation assembly. That is, the heat insulation assembly can isolate the infrared detector 106 and the circuit board assembly. The heat insulation assembly can block the heat conduction and heat radiation of the circuit board assembly to the infrared detector 106, thereby reducing the influence of the heat generated by the circuit board assembly on the accuracy of the temperature measured by the infrared detector 106. Since the circuit board assembly is the main heating component in the infrared imaging unit 10, by blocking the heat conduction and heat radiation of the circuit board assembly to the infrared detector 106, the temperature measured by the infrared detector 106 can be closer to the temperature of the measured object.

As shown in FIG. 4 and FIG. 8, in one embodiment of the present disclosure, the circuit board assembly includes a main circuit board 110 and a signal processing circuit board 112. The heat insulation assembly includes a first heat insulator 108, which may be disposed between the infrared detector 106 and the signal processing circuit board 112.

In this embodiment, the circuit board assembly includes a main circuit board 110 and a signal processing circuit board 112, and the heat insulation assembly includes a first heat insulator 108. In some embodiments, the infrared detector 106 and the first heat insulator 108 may be respectively disposed on both sides of the first heat insulator 108. That is, the first heat insulator 108 may isolate the infrared detector 106 from the signal processing circuit board 112, and the first heat insulator 108 may block the heat conduction and heat radiation from the signal processing circuit board 112 to the infrared detector 106.

As shown in FIG. 4 and FIG. 8, in one embodiment of the present disclosure, the circuit board assembly further includes a second heat insulator 114, which may be disposed between the main circuit board 110 and the signal processing circuit board 112.

In this embodiment, the second heat insulator 114 is disposed between the main circuit board 110 and the signal processing circuit board 112. The second heat insulator 114 may block the heat conduction and heat radiation from the main circuit board 110 to the signal processing circuit board 112 and the infrared detector 106, thereby reducing the influence of the heat generated by the main circuit board 110 on the accuracy of the temperature measured by the infrared detector 106, such that the temperature measured by the infrared detector 106 can be closer to the temperature of the measured object.

As shown in FIG. 4 and FIG. 8, in some embodiments, the signal processing circuit board 112 is mounted on the first heat insulator 108 by screws 136. The second heat insulator 114 may be disposed between the main circuit board 110 and the signal processing circuit board 112, and a plurality of screws 136 may pass through eh main circuit board 110, the second heat insulator 114, and the first heat insulator 108 to mount these components on a middle frame 104. An anti-vibration pad may be disposed under the screw head of the screw 136 to buffer the residual stress on the signal processing circuit board 112 and the main circuit board 110 due to the mechanical connection. The anti-vibration pad may be a rubber ring 138.

In some embodiments, the first heat insulator 108 may be a plastic first heat insulator 108. The plastic material is easy to process and shape, and the plastic material has good heat insulation performance.

As shown in FIG. 4 and FIG. 8, in one embodiment of the present disclosure, the first heat insulator 108 is configured as a cavity structure with an opening at one end, and a through hole is opened on the other end of the first heat insulator 108 opposite to the end with the opening.

In this embodiment, the first heat insulator 108 is configured as a cavity structure with an opening at one end to take advantage of the low thermal conductivity of the air in the cavity structure to further isolation the heat conduction and heat radiation of the circuit board assembly to the infrared detector 106, thereby reducing the influence of the heat generated by the circuit board assembly on the accuracy of the temperature measured by the infrared detector 106, such that the temperature measured by the infrared detector 106 can be closer to the temperature of the measured object. Further, a through hole can be opened on the other end of the first heat insulator 108 opposite to the end with the opening. The through hole can be used for the passage of a flexible circuit board 134, such that the components disposed on both sides of the first heat insulator 108 can be connected through the flexible circuit board 134.

As shown in FIG. 4 and FIG. 8, in one embodiment of the present disclosure, the circuit board assembly is connected to at least one end of the first heat insulator 108 having an opening.

As shown in FIG. 4 and FIG. 8, in one embodiment of the present disclosure, the circuit board assembly is sealed at the opening to form a heat insulating cavity with the first heat insulator 108.

In this embodiment, the circuit board assembly is connected to at least one end of the first heat insulator 108 having an opening, and the circuit board assembly is sealed at the opening to form a heat insulating cavity with the first heat insulator 108. By forming a hollow heat insulating cavity, the low thermal conductivity of the air in the heat insulating cavity can be used to further isolate the heat conduction and heat radiation of the circuit board assembly to the infrared detector 106, thereby reducing the influence of the heat generated by the circuit board assembly on the accuracy of the temperature measured by the infrared detector 106, such that the temperature measured by the infrared detector 106 can be closer to the temperature of the measured object.

As shown in FIG. 8, in some embodiments, the thickness of the heat insulating cavity may be greater than or equal to 5 mm. That is, a distance L between the circuit board assembly and the cavity bottom wall of the heat insulating cavity may be greater than or equal to 5 mm, such that a better heat insulation effected can be achieved.

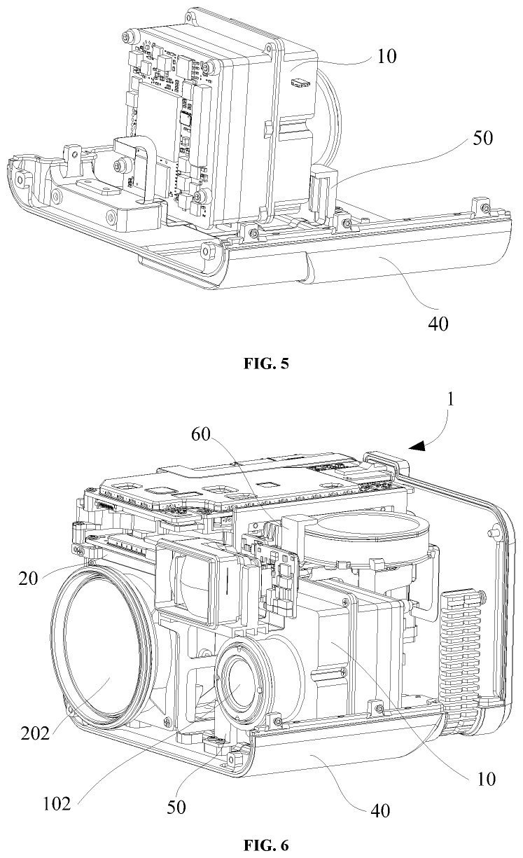

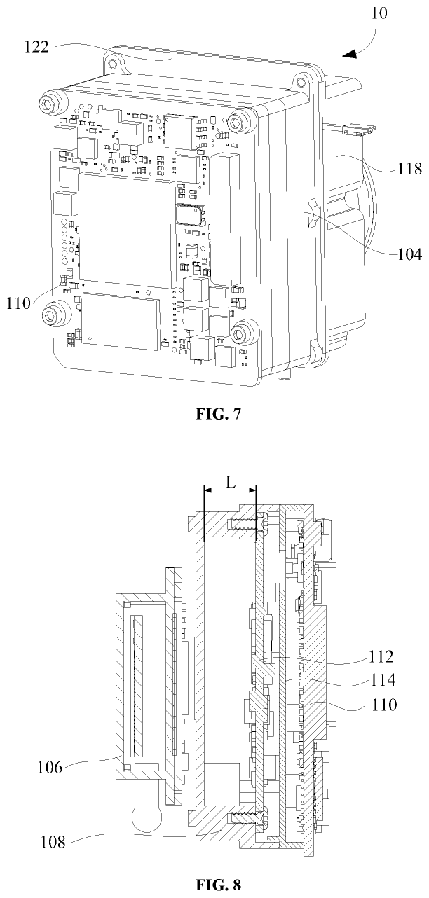

As shown in FIG. 3, FIG. 4, FIG. 5, FIG. 7, and FIG. 8, in one embodiment of the present disclosure, the infrared imaging unit 10 further includes a middle frame 104 and a front housing 118. When the front housing 118 is connected to the middle frame 104, the inside of the middle frame 104 and the front housing 118 may form an installation cavity.

In this embodiment, the infrared imaging unit 10 further includes a middle frame 104 and a front housing 118. When the front housing 118 is connected to the middle frame 104, the inside of the middle frame 104 and the front housing 118 may form an installation cavity. The installation cavity may be used to install other components, thereby protecting the components in the installation cavity.

As shown in FIG. 3, FIG. 4, FIG. 5, FIG. 7, and FIG. 8, in one embodiment of the present disclosure, when the front housing 118 and the middle frame 104 are connected, the front housing 118 and the middle frame 104 may abut against each other in a circumferential direction.

In this embodiment, by limiting the connection between the front housing 118 and the middle frame 104, the front housing 118 and the middle frame 104 may abut against each other in the circumferential direction, such that the heat transfer between the front housing 118 and the middle frame 104 can be uniform and fast, and the temperature measured by the infrared detector 106 inside the installation cavity can be more accurate.

As shown in FIG. 4 and FIG. 8, in one embodiment of the present disclosure, the heat insulation assembly is disposed outside the installation cavity, and the infrared detector 106 is disposed inside the installation cavity.

In this embodiment, the infrared detector 106 is disposed inside the installation cavity, and the heat insulation assembly is disposed outside the installation cavity. Since the circuit board assembly is disposed on the side of the heat insulation assembly away from the infrared detector 106, that is, the circuit board assembly is also disposed outside the installation cavity, the infrared detector 106 can be better separated from the circuit board assembly. In this way, the influence of the heat generated by the circuit board assembly on the accuracy of the temperature measured by the infrared detector 106 can be more effectively reduced, thereby making the temperature measured by the infrared detector 106 closer to the temperature of the measured object.

As shown in FIG. 4, in one embodiment of the present disclosure, the infrared imaging unit 10 further includes a heat conducting element 116, which may be disposed between the middle frame 104 and the infrared detector 106. One side of the infrared detector 106 may be attached to the heat conducting element 116. The middle frame 104 may be disposed on the side of the infrared detector 106 facing the heat insulation assembly.

In this embodiment, the infrared imaging unit 10 further includes a heat conducting element 116 disposed between the middle frame 104 and the infrared detector 106. One side of the infrared detector 106 may be attached to the heat conducting element 116, such that the heat on the infrared detector 106 can be transferred to the middle frame 104 through the heat conducting element 116, thereby reducing the influence of the heat generated by the infrared detector 106 on its measurement accuracy.

In some embodiments, the material of the middle frame 104 may be aluminum alloy. Aluminum alloy has good thermal conductivity, which is convenient for dissipating heat into the air through the middle frame 104. Further, the heat conducting element 116 may be a heat conductive plate or a heat conductive pad.

As shown in FIG. 3, FIG. 4, FIG. 5, and FIG. 7, in one embodiment of the present disclosure, the infrared imaging unit 10 further includes a front housing heat conducting part 120 connected to the front housing 118. The front housing heat conducting part 120 may be disposed along the circumference of the front housing 118 and may extend outward. The front housing heat conducting part 120 may abut against the middle frame 104.

In this embodiment, the front housing 118 of the infrared imaging unit 10 and the infrared imaging unit 104 may jointly define an installation cavity for installing other components. However, since the front housing 118 and the middle frame 104 are close together, a part of the heat on the middle frame 104 will inevitably be conducted to the front housing 118, causing the temperature of the parts assembled with the front housing 118 to rise, which will interfere with the measurement accuracy of the infrared detector 106. By arranging a circle of front housing heat conducting part 120 extending outward along the circumference of the front housing 118, that is, a circle of heat conducting edges designed on the front housing 118, and abutting the front housing heat conducting part 120 against the middle frame 104, the effective heat conduction cross-sectional area of the front housing 118 and the middle frame 104 can be increased, the heat of the front housing 118 and the first heat insulator 108 can be uniform, and the actual temperature difference may not exceed 1° C. in this way, the interference of the temperature of the front housing 118 and the middle frame 104 to the infrared detector 106 can be considered as uniform.

As shown in FIG. 3, FIG. 4, FIG. 5, and FIG. 7, in one embodiment of the present disclosure, the infrared imaging unit 10 further includes a middle frame heat conducting part 122, which may be connected to the middle frame 104. The middle frame heat conducting part 122 may be disposed along the circumferential direction of the middle frame 104 and may extend outward. The middle frame heat conducting part 122 may abut against the front housing heat conducting part 120.

In this embodiment, the middle frame heat conducting part 122 may also be disposed in the circumferential direction of the middle frame 104. Specifically, a circle of middle frame heat conducting part 122 extending outward may be disposed along the circumferential direction of the middle frame 104, that is, a circle of heat conducting edges may be designed on the middle frame 104, and the middle frame heat conducting part 122 may be arranged to abut against the middle frame heat conducting part 122. In this way, the effective heat conduction cross-sectional area of the front housing 118 and the middle frame 104 can be further increased, which further makes the heat of the front housing 118 and the middle frame 104 uniform.

As shown in FIG. 4, in one embodiment of the present disclosure, the infrared imaging unit 10 further includes a first temperature sensor 30 disposed in the front housing 118. The first temperature sensor 30 can be used to measure the interference temperature inside the infrared imaging unit 10 to the infrared detector 106.

In this embodiment, since the heat of the front housing 118 and the middle frame 104 is uniform, the actual temperature difference may not exceed 1° C., that is, the interference of the temperature of the front housing 118 and the middle frame 104 to the infrared detector 106 can be considered as uniform. By arranging the first temperature sensor 30 in the front housing 118, the interference temperature of the front housing 118, the middle frame 104, and the components mounted inside the front housing 118 and the middle frame 104 on the infrared detector 106 can be obtained in real time. That is, the temperature measured by the first temperature sensor 30 can be the interference temperature of the infrared imaging unit 10 to the infrared detector 106.

It can be understood that after the infrared imaging unit 10 starts to work, some parts inside the infrared imaging unit 10 will generate heat, causing the temperature of itself and the surrounding parts to rise. This part of the increased temperature will radiate energy outward in the form of infrared radiation, which will affect the temperature measurement accuracy of the infrared detector 106. Since the infrared imaging unit 10 is disposed in the housing 40, in the temperature obtained by the infrared detector 106, the interference temperature inside the infrared imaging unit 10 to the infrared detector 106 and the temperature inside the housing 40 of the imaging device 1 can affect the measurement accuracy of the infrared detector 106. By arranging the first temperature sensor 30 in the front housing 118, the temperature measured by the first temperature sensor 30 can be the interference temperature inside the infrared imaging unit 10 to the infrared detector 106. By subtracting the temperature measured by the first temperature sensor 30 form the temperature measured by the infrared detector 106, the interference temperature inside the infrared imaging unit 10 to the infrared detector 106 can be eliminated, and the measurement accuracy of the infrared detector 106 can be improved.

As shown in FIG. 1, FIG. 2, FIG. 3, FIG. 4, and FIG. 6, in one embodiment of the present disclosure, the infrared imaging unit 10 further includes an infrared imaging unit lens 102, and an optical element installation position disposed on the front housing 118. The infrared imaging unit lens 102 of the infrared imaging unit may be installed in the optical element installation position.

In this embodiment, by arranging the optical element installation position on the front housing 118, the infrared imaging unit lens 102 can be installed on the front housing 118 and positioned at the optical element installation position. The optical element installation position can facilitate the installation of the infrared imaging unit lens 102. Further, the infrared detector 106 may be coaxially disposed with the infrared imaging unit lens 102.

As shown in FIG. 4, in one embodiment of the present disclosure, the infrared imaging unit 10 further includes a first sealing ring 124 disposed on the front housing 118. The infrared imaging unit lens 102 may include threads, and the infrared imaging unit lens 102 may be assembled on the front housing 118 through the threads. The infrared imaging unit 10 further includes a second sealing ring 126 disposed on the infrared imaging unit lens 102. The second sealing ring 126 can be used to seal the connection between the front housing 118 and the infrared imaging unit lens 102.

In this embodiment, the infrared imaging unit 10 further includes a first sealing ring 124 disposed on the front housing 118, and the first sealing ring 124 can be used to seal the connection between the front housing 118 and the housing 40 to provide waterproof performance of the imaging device 1. The infrared imaging unit lens 102 can be arranged with threads for assembling with the front housing 118, and the second sealing ring 126 can be disposed on the infrared imaging unit lens 102. The second sealing ring 126 can prevent water from entering the infrared imaging unit lens 102, making it waterproof.

As shown in FIG. 4, in one embodiment of the present disclosure, the infrared imaging unit 10 further includes a detector circuit board 128 fixedly connected to the infrared detector 106, and connected to the middle frame 104; a detector cover 130 connected to the middle frame 104, the detector cover 130 being arranged to cover a part of the infrared detector 106; and a shutter 132 connected to the middle frame 104.

In this embodiment, the infrared imaging unit 10 further includes a detector circuit board 128, a detector cover 130, and a shutter 132. Further, after the infrared detector 106 is welded and connected to the detector circuit board 128, it may be installed on the middle frame 104 by screws 136. The detector cover 130 may be installed on the infrared detector 106 by screws 136. The detector cover 130 can play a role of shielding the non-sensing area of the infrared detector 106 to reduce the radiation interference of the internal parts of the infrared imaging unit 10 by the infrared detector 106. The shutter 132 may be installed on the middle frame 104 through a positioning post and a screw 136 provided thereon. The shutter 132 can be used to eliminate the integral drift of the temperature measured by the infrared detector 106.

As shown in FIG. 4, in one embodiment of the present disclosure, the infrared imaging unit 10 further includes a flexible circuit board 134 connected to the detector circuit board 128 and the signal processing circuit board 112 to realize the transmission of electrical signals.

In this embodiment, the infrared imaging unit 10 further includes a flexible circuit board 134 connecting the detector circuit board 128 and the signal processing circuit board 112. The flexible circuit board 134 can be used to realize the transmission of electrical signals between the detector circuit board 128 and the signal processing circuit board 112.

As shown in FIG. 4, in one embodiment of the present disclosure, the heat conducting element 116, the detector circuit board 128, the detector cover 130, the shutter 132, and the flexible circuit board 134 can be disposed in the installation cavity.

In this embodiment, by disposing the heat conducting element 116, the detector circuit board 128, the detector cover 130, the shutter 132, the flexible circuit board 134, the infrared detector 106, and other components in the installation cavity, the installation cavity formed by the front housing 118 and the middle frame 104 can protect the aforementioned components.

As shown in FIG. 1, FIG. 2, and FIG. 6, a second aspect of the present disclosure provides an imaging device 1. The imaging device 1 includes a visible light imaging unit 20 and the infrared imaging unit 10. The infrared imaging unit lens 102 and a visible light imaging unit lens 202 may face the same direction. The infrared imaging unit 10 may include an infrared detector 106 and a heat insulation assembly disposed on one side of the infrared detector 106. The heat insulation assembly can be used to isolate the transfer of heat in the imaging device 1 to the infrared detector 106.

The imaging device 1 provided in the embodiments of the present disclosure may include an infrared imaging unit 10 and a visible light imaging unit 20, and the infrared imaging unit 10 and the visible light imaging unit 20 may be integrated on the imaging device 1. On one hand, the user may obtain the infrared image information of the measured object through the infrared imaging unit 10 of the imaging device 1, and obtain the visible light image information of the measured object through the visible light imaging unit 20 of the imaging device 1, thereby gaining an intuitive visual understanding of the measured object, and obtaining more comprehensive information of the measured object. On the other hand, by integrating the infrared imaging unit 10 and the visible light imaging unit 20 on the imaging device 1, the size and weight of the imaging device 1 can be reduced, which is convenient for maintenance during subsequent use. Further, the infrared imaging unit lens 102 and the visible light imaging unit lens 202 can face the same direction, such that the infrared imaging unit 10 and the visible light imaging unit 20 can photograph the measured object in the same orientation. In this way, it is convenient for the user to combine the obtained infrared image information of the measured object with the visible light image information of the measured object, such that the surrounding environment of the imaging device 1 can be accurately analyzed, and the condition of the measured object can be comprehensively identified. Further, the infrared imaging unit 10 in the imaging device 1 provided in the present disclosure may include an infrared detector 106 and a heat insulation assembly. The heat insulation assembly may be disposed on one side of the infrared detector 106. The heat insulation assembly can be block the heat conduction and heat radiation of the heating components in the imaging device 1 to the infrared detector 106, thereby reducing the influence of the heat generated in the imaging device 1 on the accuracy of the temperature measured by the infrared detector 106, such that the temperature measured by the infrared detector 106 can be closer to the temperature of the measured object.

In one embodiment, the heat insulation assembly may block the heat conduction and heat radiation of the heating parts in the infrared imaging unit 10 to the infrared detector 106, thereby reducing the influence of the heat generated in the infrared imaging unit 10 on the accuracy of the temperature measured by the infrared detector 106.

It can be understood that, as shown in FIG. 1 to FIG. 6, the imaging or temperature measurement of the infrared imaging unit 10 mainly relies on its internal infrared detector 106 to obtain the infrared radiation of the object, and after processing, the temperature of the to-be-measured object can be obtained. The temperature measurement accuracy of the infrared detector 106 is mainly affected by three factors, namely, the surface characteristics of the measured object (emissivity and absorptivity), environmental radiation, and internal radiation of the imaging device 1. Therefore, the temperature measured by the infrared detector 106 may be expressed by the following mathematical formula (1):

Te+Tc+To=T

In the mathematical formula (1), Te is the external environment temperature of the imaging device 1, Tc is the internal temperature of the imaging device 1, To is the temperature of the to-be-measured object, and T is the temperature measured by the infrared detector 106.

The imaging device 1 provided in the present disclosure can integrate an infrared imaging unit 10 and a visible light imaging unit 20. After the imaging device 1 starts to work, some parts inside the imaging device 1 will generate heat, causing the temperature of itself and the surrounding parts to rise. This part of the increased temperature will radiate energy outward in the form of infrared radiation, which will affect the temperature measurement accuracy of the infrared detector 106. Since the infrared imaging unit 10 is disposed in the housing 40, in the temperature obtained by the infrared detector 106, a temperature T1 inside the housing 40 of the imaging device 1 and an interference temperature T2 inside the infrared imaging unit 10 to the infrared detector 106 may affect the measurement accuracy of the infrared detector 106. That is, in the mathematical formula (1) of the temperature measured by the infrared detector 106, the internal temperature Tc of the imaging device 1 may include two parts, namely the temperature T1 inside the housing 40 of the imaging device 1 and the interference temperature T2 inside the infrared imaging unit 10 to the infrared detector 106. That is, Tc=T1+T2. In this formula, T1 is the temperature inside the housing 40 of the imaging device 1, and T2 is the interference temperature inside the infrared imaging unit 10 to the infrared detector 106. Therefore, the temperature measured by the infrared detector 106 may be expressed by the following mathematical formula (2):

Te+T1+T2+To=T_{∘}

Since the temperature T measured by the infrared detector 106 can be obtained, in order to improve the accuracy of the temperature To of the measured object, the present disclosure uses a plurality of temperature sensors in the imaging device 1 to measure the interference temperature inside the infrared imaging unit 10 to the infrared detector 106, the temperature inside the housing 40, and the external environment temperature where the imaging device 1 is positioned. Specifically, in one embodiment, a first temperature sensor 30, a second temperature sensor 50, and a third temperature sensor 60 may be respectively disposed in the imaging device 1. In some embodiments, the first temperature sensor 30 may be disposed inside the infrared imaging unit 10 for detecting the temperature inside the infrared imaging unit 10. The second temperature sensor 50 may be disposed inside the housing 40 for detecting the temperature in the housing 40. The temperature of the housing 40 may include, but is not limited to, the temperature of the visible light imaging unit 20 and the temperature of other heat-generating parts in the imaging device 1. Further, the second temperature sensor 50 may be disposed as close to the infrared imaging unit 10 as possible to more accurately determine the influence of the temperature of the infrared imaging unit 10 from inside the housing of the imaging device 1. The third temperature sensor 60 may be used to detect the external environment temperature where the imaging device 1 is positioned. Further, the third temperature sensor 60 may be disposed at a place where the imaging device 1 and the outside air circulate, for example, the third temperature sensor 60 can be disposed at an air duct of the imaging device 1 to more accurately determine the influence of the external environment of the imaging device 1 on the temperature of the infrared imaging unit 10.

In one embodiment, the first temperature sensor 30 may be disposed on the front housing 118 of the imaging device 1, and the temperature measured by the first temperature sensor 30 may be the interference temperature T2 of the infrared imaging unit 10 to the infrared detector 106 through specific structural improvements. The second temperature sensor 50 may be disposed in the second temperature sensor 50, such that the second temperature sensor 50 can detect the temperature in the housing 40, that is, the temperature T1 inside the housing 40 of the imaging device 1. The third temperature sensor 60 may be disposed at an air inlet of the housing 40, such that the third temperature sensor 60 can detect the temperature Te of the external environment where the imaging device 1 is positioned. On the basis of the temperature T measured by the infrared detector 106, subtract the temperature measured by the first temperature sensor 30, the temperature measured by the second temperature sensor 50, and the temperature measured by the third temperature sensor 60, the temperature To of the measured object can be obtained. By eliminating the internal temperature of the imaging device 1, the interference temperature of the infrared imaging unit 10 on the infrared detector 106, and the interference of the external environment temperature of the imaging device 1 on the infrared detector 106, the accuracy of the temperature To of the measured object can be improved.

It can be understood that the number and position of the temperature sensors are not limited to the above-mentioned embodiments, and an appropriate number of temperature sensors can be set at appropriate positions based on actual needs, which is not limited in here.

As shown in FIG. 4 and FIG. 8, in one embodiment of the present disclosure, the infrared imaging unit 10 further includes a circuit board assembly. The circuit board assembly may be disposed on the side of the heat insulation assembly away from the infrared detector 106.

In this embodiment, the infrared imaging unit 10 includes an infrared detector 106, a circuit board assembly, and a heat insulation assembly, where the infrared detector 106 and the circuit board assembly may be respectively disposed on both sides of the heat insulation assembly. That is, the heat insulation assembly can separate the infrared detector 106 from the circuit board assembly. The heat insulation assembly can block the heat conduction and heat radiation of the circuit board assembly to the infrared detector 106, thereby reducing the influence of the heat generated by the circuit board assembly on the accuracy of the temperature measured by the infrared detector 106. Since the circuit board assembly is the main heating component in the infrared imaging unit 10, by blocking the heat conduction and heat radiation of the circuit board assembly to the infrared detector 106, the temperature measured by the infrared detector 106 can be closer to the temperature of the measured object.

In one embodiment of the present disclosure, the imaging device 1 may further include a temperature measuring device assembly, which may be disposed on the visible light imaging unit and/or the infrared imaging unit 10. The temperature measuring device assembly may be used to measure the internal temperature and/or the external environment temperature of the imaging device 1.

In this embodiment, by arranging the temperature measuring device assembly on the visible light imaging unit and/or the infrared imaging unit 10, the internal temperature and/or the external environment temperature of the imaging device 1 can be measured. That is, the interference temperature of the infrared detector 106 from the internal and/or external environment of the imaging device 1 can be obtained in real time through the temperature measuring device assembly, thereby reducing the influence of the interference temperature on the accuracy of the temperature measured by the infrared detector 106, such that the temperature measured by the infrared detector 106 can be closer to the temperature of the measured object.

In one embodiment of the present disclosure, the circuit board assembly may include a main circuit board 110 and a signal processing circuit board 112. The heat insulation assembly may include a first heat insulator 108, which may be disposed between the infrared detector 106 and the signal processing circuit board 112; and a second heat insulator 114, which may be disposed between the main circuit board 110 and the signal processing circuit board 112.

In this embodiment, the circuit board assembly may include a main circuit board 110 and a signal processing circuit board 112, and the heat insulation assembly may include a first heat insulator 108 and a second heat insulator 114. In some embodiments, the infrared detector 106 and the first heat insulator 108 may be respectively disposed on both sides of the first heat insulator 108. That is, the first heat insulator 108 may isolate the infrared detector 106 from the signal processing circuit board 112, and the first heat insulator 108 may block the heat conduction and heat radiation from the signal processing circuit board 112 to the infrared detector 106. Further, the second heat insulator 114 may be disposed between the main circuit board 110 and the signal processing circuit board 112. The second heat insulator 114 may block the heat conduction and heat radiation from the main circuit board 110 to the signal processing circuit board 112 and the infrared detector 106, thereby reducing the influence of the heat generated by the main circuit board 110 on the accuracy of the temperature measured by the infrared detector 106, such that the temperature measured by the infrared detector 106 can be closer to the temperature of the measured object. Specifically, the signal processing circuit board 112 may be mounted on the first heat insulator 108 by screws. The second heat insulator 114 may be disposed between the main circuit board 110 and the signal processing circuit board 112, and screws may pass through the main circuit board 110, the second heat insulator 114, and the first heat insulator 108, and mount these parts on the middle frame. An anti-vibration pad may be disposed under the screw head of the screw to buffer the residual stress caused by the mechanical connection on the signal processing circuit board 112 and the main circuit board 110. The anti-vibration pad may be a rubber ring 138.

In some embodiments, the first heat insulator 108 may be a plastic first heat insulator. The plastic material is easy to process and shape, and the plastic material has good heat insulation performance.

As shown in FIG. 4 and FIG. 8, in one embodiment of the present disclosure, the first heat insulator 108 is configured as a cavity structure with an opening at one end. The circuit board assembly is connected to the opening end of the first heat insulator 108, and is sealed at the opening to form a heat insulating cavity with the first heat insulator 108.

In this embodiment, the first heat insulator 108 is constructed as a cavity structure with an opening at one end, and the circuit board assembly is sealed at the opening to form a heat insulating cavity with the first heat insulator 108. By forming a hollow heat insulating cavity, the low thermal conductivity of the air in the heat insulating cavity can be used to further isolate the heat conduction and heat radiation of the circuit board assembly to the infrared detector 106, thereby reducing the influence of the heat generated by the circuit board assembly on the accuracy of the temperature measured by the infrared detector 106, such that the temperature measured by the infrared detector 106 can be closer to the temperature of the measured object. Further, the thickness of the heat insulating cavity may be greater than or equal to 5 mm. That is, a distance L between the circuit board assembly and the cavity bottom wall of the heat insulating cavity may be greater than or equal to 5 mm, such that a better heat insulation effected can be achieved.

As shown in FIG. 4, in one embodiment of the present disclosure, the infrared imaging unit 10 further includes a middle frame 104 disposed on the side of the infrared detector 106 facing the heat insulation assembly; a heat conducting element 116 disposed between the middle frame 104 and the infrared detector 106. One side of the infrared detector 106 may be attached to the heat conducting element 116.

In this embodiment, the infrared imaging unit 10 further includes a middle frame 104 and a heat conducting element 116 disposed between the middle frame 104 and the infrared detector 106. One side of the infrared detector 106 may be attached to the heat conducting element 116, such that the heat on the infrared detector 106 can be transferred to the middle frame 104 through the heat conducting element 116, thereby reducing the influence of the heat generated by the infrared detector 106 on its measurement accuracy. Further, the material of the middle frame 104 may be aluminum alloy. Aluminum alloy has good thermal conductivity, which is convenient for dissipating heat into the air through the middle frame 104. Further, the heat conducting element 116 may be a heat conductive plate or a heat conductive pad.

As shown in FIG. 3, FIG. 4, and FIG. 7, in one embodiment of the present disclosure, the infrared imaging unit 10 further includes a front housing 118 connected to the middle frame 104, and a front housing heat conducting part 120 connected to the front housing 118. The front housing heat conducting part 120 may be disposed along the circumferential direction of the front housing 118 and extend outward, and the infrared imaging unit lens 102 may abut against the middle frame 104.

In this embodiment, the infrared imaging unit 10 further includes a front housing 118 connected to the middle frame 104. The front housing 118 and the middle frame 104 may jointly define an installation cavity for installing other components. However, since the front housing 118 and the middle frame 104 are close together, a part of the heat on the middle frame 104 will inevitably be conducted to the front housing 118, causing the temperature of the parts assembled with the front housing 118 to rise, which will interfere with the measurement accuracy of the infrared detector 106. By arranging a circle of front housing heat conducting part 120 extending outward along the circumference of the front housing 118, that is, a circle of heat conducting edges designed on the front housing 118, and abutting the front housing heat conducting part 120 against the middle frame 104, the effective heat conduction cross-sectional area of the front housing 118 and the middle frame 104 can be increased, the heat of the front housing 118 and the first heat insulator 108 can be uniform, and the actual temperature difference may not exceed 1° C. in this way, the interference of the temperature of the front housing 118 and the middle frame 104 to the infrared detector 106 can be considered as uniform.

As shown in FIG. 3, FIG. 4, and FIG. 7, in one embodiment of the present disclosure, the infrared imaging unit 10 further includes a middle frame heat conducting part 122 connected to the middle frame 104. The middle frame heat conducting part 122 may be disposed along the circumferential direction of the middle frame 104 and may extend outward. The middle frame heat conducting part 122 may abut against the front housing heat conducting part 120.

In this embodiment, the middle frame heat conducting part 122 may also be disposed in the circumferential direction of the middle frame 104. Specifically, a circle of middle frame heat conducting part 122 extending outward may be disposed along the circumferential direction of the middle frame 104, that is, a circle of heat conducting edges may be designed on the middle frame 104, and the middle frame heat conducting part 122 may be arranged to abut against the middle frame heat conducting part 122. In this way, the effective heat conduction cross-sectional area of the front housing 118 and the middle frame 104 can be further increased, which further makes the heat of the front housing 118 and the middle frame 104 uniform.

As shown in FIG. 4, the temperature measuring device assembly includes a first temperature sensor 30 disposed in the front housing 118. The first temperature sensor 30 can be used to measure the interference temperature inside the infrared imaging unit 10 to the infrared detector 106.

In this embodiment, since the heat of the front housing 118 and the middle frame 104 is uniform, the actual temperature difference may not exceed 1° C., that is, the interference of the temperature of the front housing 118 and the middle frame 104 to the infrared detector 106 can be considered as uniform. By arranging the first temperature sensor 30 in the front housing 118, the interference temperature of the front housing 118, the middle frame 104, and the components mounted inside the front housing 118 and the middle frame 104 on the infrared detector 106 can be obtained in real time. That is, the temperature measured by the first temperature sensor 30 can be the interference temperature of the infrared imaging unit 10 to the infrared detector 106.

It can be understood that after the imaging device 1 starts to work, some parts inside the imaging device 1 will generate heat, causing the temperature of itself and the surrounding parts to rise. This part of the increased temperature will radiate energy outward in the form of infrared radiation, which will affect the temperature measurement accuracy of the infrared detector 106. Since the infrared imaging unit 10 is disposed in the housing 40, in the temperature obtained by the infrared detector 106, the interference temperature inside the infrared imaging unit 10 to the infrared detector 106 and the temperature inside the housing 40 of the imaging device 1 can affect the measurement accuracy of the infrared detector 106. In the imaging device 1 provided by the present disclosure, by using the first temperature sensor 30 in the front housing 118, the temperature measured by the first temperature sensor 30 can be the interference temperature inside the infrared imaging unit 10 to the infrared detector 106. By subtracting the temperature measured by the first temperature sensor 30 form the temperature measured by the infrared detector 106, the interference temperature inside the infrared imaging unit 10 to the infrared detector 106 can be eliminated, and the measurement accuracy of the infrared detector 106 can be improved.

As shown in FIG. 2, FIG. 5, and FIG. 6, in one embodiment of the present disclosure, the imaging device 1 further includes a housing 40. The visible light imaging unit 20 and the infrared imaging unit 10 may be disposed in the housing 40. The temperature measuring device assembly includes a second temperature sensor 50. The second temperature sensor 50 can be disposed in the housing 40, and the second temperature sensor 50 can be used to measure the interference temperature of the imaging device 1 to the infrared imaging unit 10.

In this embodiment, the imaging device 1 further includes a housing 40, and the temperature measuring device assembly includes a second temperature sensor 50. In some embodiments, the visible light imaging unit 20, the infrared imaging unit 10, and the second temperature sensor 50 may be all disposed in the housing 40, and the second temperature sensor 50 may detect the temperature in the housing 40, that is, the temperature inside the housing 40 of the imaging device 1.

It can be understood that after the imaging device 1 starts to work, some parts inside the imaging device 1 will generate heat, causing the temperature of itself and the surrounding parts to rise. This part of the increased temperature will radiate energy outward in the form of infrared radiation, which will affect the temperature measurement accuracy of the infrared detector 106. Since the infrared imaging unit 10 is disposed in the housing 40, in the temperature obtained by the infrared detector 106, the interference temperature inside the infrared imaging unit 10 to the infrared detector 106 and the temperature inside the housing 40 of the imaging device 1 can affect the measurement accuracy of the infrared detector 106. In the imaging device 1 provided by the present disclosure, by using the second temperature sensor 40 in the housing 40, the second temperature sensor 50 can detect the temperature in the housing 40, that is, the temperature inside the housing 40 of the imaging device 1. The temperature inside the housing 40 may include, but is not limited to, the temperature of the visible light imaging unit 20 and the temperature of other heat-generating components in the imaging device 1. Further, the second temperature sensor 50 may be disposed as close as possible to the infrared imaging unit 10 to more accurately determine the influence of the temperature of the infrared imaging unit 10 inside the housing of the imaging device 1. On the basis of the temperature measured by the infrared detector 106, the temperature measured by the second temperature sensor 50 can be subtracted to eliminate the interference of the internal temperature of the imaging device 1 on the infrared detector 106 and improve the measurement accuracy of the infrared detector 106.

As shown in FIG. 5, in one embodiment of the present disclosure, there is a gap between the front housing 118 and the housing 40.

In this embodiment, there is a gap between the front housing 118 of the infrared imaging unit 10 and the housing 40. That is, the front housing 118 is not directly attached to the housing 40. On one hand, the heat on the housing 40 can be prevented from being transferred to the front housing 118 to eliminate the interference of the temperature of the housing 40 on the infrared detector 106 as much as possible, and to improve the measurement accuracy of the infrared detector 106. On the other hand, the gap also makes the heat dissipation of the front housing 118 faster, such that the temperature measurement of the infrared detector 106 positioned in the front housing 118 can be more accurate. As shown in FIG. 4 and FIG. 6, in one embodiment of the present disclosure, the imaging device 1 further includes an air inlet (not shown in the accompanying drawings) disposed on the housing 40. The air inlet can communicate with the outside of the housing 40 and the inside of the housing 40. The temperature measuring device assembly includes a third temperature sensor 60, which is disposed in the housing 40 and positioned at the air inlet.

In this embodiment, the housing 40 further includes an air inlet connecting the inside of the housing 40 and the outside of the housing 40, and the third temperature sensor 60 is disposed at the air inlet. The temperature measured by the third temperature sensor 60 can be the temperature outside the housing 40, that is, the ambient temperature of the imaging device 1.

It can be understood that the imaging or temperature measurement of the infrared imaging unit 10 mainly relies on its internal infrared detector 106 to obtain the infrared radiation of the object, and after processing, the temperature of the to-be-measured object can be obtained. The temperature measurement accuracy of the infrared detector 106 can be affected by the ambient temperature. In the imaging device 1 provided by the present disclosure, by disposed the third temperature sensor 60 at the air inlet of the housing 40, the third temperature sensor 60 can detect the ambient temperature of the imaging device 1. On the basis of the temperature measured by the infrared detector 106, the temperature measured by the third temperature sensor 60 can be subtracted to eliminate the interference of the ambient temperature of the imaging device 1 on the infrared detector 106 and improve the measurement accuracy of the infrared detector 106.

As shown in FIG. 4, in one embodiment of the present disclosure, the infrared imaging unit 10 further includes a first sealing ring 124 disposed on the front housing 118. The infrared imaging unit lens 102 may include threads, and the infrared imaging unit lens 102 may be assembled on the front housing 118 through the threads. The infrared imaging unit 10 further includes a second sealing ring 126 disposed on the infrared imaging unit lens 102. The second sealing ring 126 can be used to seal the connection between the front housing 118 and the infrared imaging unit lens 102.

In this embodiment, the infrared imaging unit 10 further includes a first sealing ring 124 disposed on the front housing 118, and the first sealing ring 124 can be used to seal the connection between the front housing 118 and the housing 40 to provide waterproof performance of the imaging device 1. The infrared imaging unit lens 102 can be arranged with threads for assembling with the front housing 118, and the second sealing ring 126 can be disposed on the infrared imaging unit lens 102. The second sealing ring 126 can prevent water from entering the infrared imaging unit lens 102, making it waterproof.

As shown in FIG. 4, in one embodiment of the present disclosure, the infrared imaging unit 10 further includes a detector circuit board 128 fixedly connected to the infrared detector 106, and connected to the middle frame 104; a detector cover 130 connected to the middle frame 104, the detector cover 130 being arranged to cover a part of the infrared detector 106; and a shutter 132 connected to the middle frame 104.

In this embodiment, the infrared imaging unit 10 further includes a detector circuit board 128, a detector cover 130, and a shutter 132. Further, after the infrared detector 106 is welded and connected to the detector circuit board 128, it may be installed on the middle frame 104 by screws 136. The detector cover 130 may be installed on the infrared detector 106 by screws 136. The detector cover 130 can play a role of shielding the non-sensing area of the infrared detector 106 to reduce the radiation interference of the internal parts of the infrared imaging unit 10 by the infrared detector 106. The shutter 132 may be installed on the middle frame 104 through a positioning post and a screw 136 provided thereon. During the operation of the infrared imaging unit 10, the shutter may be opened once every certain preset period of time. At this time, the infrared detector 106 may be blocked, such that the infrared detector 106 can perform temperature correction to eliminate the integral drift of the temperature measured by the infrared detector 106 and prevent the temperature error drift from getting bigger and bigger.

As shown in FIG. 4, in one embodiment of the present disclosure, the infrared imaging unit 10 further includes a flexible circuit board 134 connected to the detector circuit board 128 and the signal processing circuit board 112 to realize the transmission of electrical signals.

In this embodiment, the infrared imaging unit 10 further includes a flexible circuit board 134 connecting the detector circuit board 128 and the signal processing circuit board 112. The flexible circuit board 134 can be used to realize the transmission of electrical signals between the detector circuit board 128 and the signal processing circuit board 112.

As shown in FIG. 1 to FIG. 8, consistent with the present disclosure, the imaging device 1 provided by the present disclosure integrates an infrared imaging unit 10 and a visible light imaging unit 20. Through thermal design, and the design of the first temperature sensor 30, the second temperature sensor 50, and the third temperature sensor 60, corrections can be made on the basis of the temperature measured by the infrared detector 106, thereby improving the temperature measurement accuracy of the to-be-measured object, such that the imaging device 1 can provide clearer and more accurate results in temperature measurement and thermal imaging.

As shown in FIG. 1, FIG. 2, and FIG. 6, a third aspect of the present disclosure provides a UAV. The UAV may include a body, a power device configured to provide power for the UAV, and the imaging device 1. The imaging device 1 may include the visible light imaging unit 20 and the infrared imaging unit 10, and the infrared imaging unit lens 102 and the visible light imaging unit lens 202 may face the same direction. The infrared imaging unit 10 may include an infrared detector 106 and a heat insulation assembly disposed on one side of the infrared detector 106. The heat insulation assembly can be used to isolate the transfer of heat in the imaging device 1 to the infrared detector 106.

The UAV provided in the present disclosure may include the body, power device, and imaging device 1.

The imaging device 1 provided in the embodiments of the present disclosure may include an infrared imaging unit 10 and a visible light imaging unit 20, and the infrared imaging unit 10 and the visible light imaging unit 20 may be integrated on the imaging device 1. On one hand, the user may obtain the infrared image information of the measured object through the infrared imaging unit 10 of the imaging device 1, and obtain the visible light image information of the measured object through the visible light imaging unit 20 of the imaging device 1, thereby gaining an intuitive visual understanding of the measured object, and obtaining more comprehensive information of the measured object. On the other hand, by integrating the infrared imaging unit 10 and the visible light imaging unit 20 on the imaging device 1, the size and weight of the imaging device 1 can be reduced, which is convenient for maintenance during subsequent use. Further, the infrared imaging unit lens 102 and the visible light imaging unit lens 202 can face the same direction, such that the infrared imaging unit 10 and the visible light imaging unit 20 can photograph the measured object in the same orientation. In this way, it is convenient for the user to combine the obtained infrared image information of the measured object with the visible light image information of the measured object, such that the surrounding environment of the imaging device 1 can be accurately analyzed, and the condition of the measured object can be comprehensively identified. Further, the infrared imaging unit 10 in the imaging device 1 provided in the present disclosure may include an infrared detector 106 and a heat insulation assembly. The heat insulation assembly may be disposed on one side of the infrared detector 106. The heat insulation assembly can be block the heat conduction and heat radiation of the heating components in the imaging device 1 to the infrared detector 106, thereby reducing the influence of the heat generated in the imaging device 1 on the accuracy of the temperature measured by the infrared detector 106, such that the temperature measured by the infrared detector 106 can be closer to the temperature of the measured object.

In one embodiment, the heat insulation assembly may block the heat conduction and heat radiation of the heating parts in the infrared imaging unit 10 to the infrared detector 106, thereby reducing the influence of the heat generated in the infrared imaging unit 10 on the accuracy of the temperature measured by the infrared detector 106.

It can be understood that, as shown in FIG. 1 to FIG. 6, the imaging or temperature measurement of the infrared imaging unit 10 mainly relies on its internal infrared detector 106 to obtain the infrared radiation of the object, and after processing, the temperature of the to-be-measured object can be obtained. The temperature measurement accuracy of the infrared detector 106 is mainly affected by three factors, namely, the surface characteristics of the measured object (emissivity and absorptivity), environmental radiation, and internal radiation of the imaging device 1. Therefore, the temperature measured by the infrared detector 106 may be expressed by the following mathematical formula (1):

Te+Tc+To=T

In the mathematical formula (1), Te is the external environment temperature of the imaging device 1, Tc is the internal temperature of the imaging device 1, To is the temperature of the to-be-measured object, and T is the temperature measured by the infrared detector 106.

The imaging device 1 provided in the present disclosure can integrate an infrared imaging unit 10 and a visible light imaging unit 20. After the imaging device 1 starts to work, some parts inside the imaging device 1 will generate heat, causing the temperature of itself and the surrounding parts to rise. This part of the increased temperature will radiate energy outward in the form of infrared radiation, which will affect the temperature measurement accuracy of the infrared detector 106. Since the infrared imaging unit 10 is disposed in the housing 40, in the temperature obtained by the infrared detector 106, a temperature T1 inside the housing 40 of the imaging device 1 and an interference temperature T2 inside the infrared imaging unit 10 to the infrared detector 106 may affect the measurement accuracy of the infrared detector 106. That is, in the mathematical formula (1) of the temperature measured by the infrared detector 106, the internal temperature Tc of the imaging device 1 may include two parts, namely the temperature T1 inside the housing 40 of the imaging device 1 and the interference temperature T2 inside the infrared imaging unit 10 to the infrared detector 106. That is, Tc=T1+T2. In this formula, T1 is the temperature inside the housing 40 of the imaging device 1, and T2 is the interference temperature inside the infrared imaging unit 10 to the infrared detector 106. Therefore, the temperature measured by the infrared detector 106 may be expressed by the following mathematical formula (2):

Te+T1+T2+To=T_{∘}

Since the temperature T measured by the infrared detector 106 can be obtained, in order to improve the accuracy of the temperature To of the measured object, the present disclosure uses a plurality of temperature sensors in the imaging device 1 to measure the interference temperature inside the infrared imaging unit 10 to the infrared detector 106, the temperature inside the housing 40, and the external environment temperature where the imaging device 1 is positioned. Specifically, in one embodiment, a first temperature sensor 30, a second temperature sensor 50, and a third temperature sensor 60 may be respectively disposed in the imaging device 1. In some embodiments, the first temperature sensor 30 may be disposed inside the infrared imaging unit 10 for detecting the temperature inside the infrared imaging unit 10. The second temperature sensor 50 may be disposed inside the housing 40 for detecting the temperature in the housing 40. The temperature of the housing 40 may include, but is not limited to, the temperature of the visible light imaging unit 20 and the temperature of other heat-generating parts in the imaging device 1. Further, the second temperature sensor 50 may be disposed as close to the infrared imaging unit 10 as possible to more accurately determine the influence of the temperature of the infrared imaging unit 10 from inside the housing of the imaging device 1. The third temperature sensor 60 may be used to detect the external environment temperature where the imaging device 1 is positioned. Further, the third temperature sensor 60 may be disposed at a place where the imaging device 1 and the outside air circulate, for example, the third temperature sensor 60 can be disposed at an air duct of the imaging device 1 to more accurately determine the influence of the external environment of the imaging device 1 on the temperature of the infrared imaging unit 10.

In one embodiment, the first temperature sensor 30 may be disposed on the front housing 118 of the imaging device 1, and the temperature measured by the first temperature sensor 30 may be the interference temperature T2 of the infrared imaging unit 10 to the infrared detector 106 through specific structural improvements. The second temperature sensor 50 may be disposed in the second temperature sensor 50, such that the second temperature sensor 50 can detect the temperature in the housing 40, that is, the temperature T1 inside the housing 40 of the imaging device 1. The third temperature sensor 60 may be disposed at an air inlet of the housing 40, such that the third temperature sensor 60 can detect the temperature Te of the external environment where the imaging device 1 is positioned. On the basis of the temperature T measured by the infrared detector 106, subtract the temperature measured by the first temperature sensor 30, the temperature measured by the second temperature sensor 50, and the temperature measured by the third temperature sensor 60, the temperature To of the measured object can be obtained. By eliminating the internal temperature of the imaging device 1, the interference temperature of the infrared imaging unit 10 on the infrared detector 106, and the interference of the external environment temperature of the imaging device 1 on the infrared detector 106, the accuracy of the temperature To of the measured object can be improved.

It can be understood that the number and position of the temperature sensors are not limited to the above-mentioned embodiments, and an appropriate number of temperature sensors can be set at appropriate positions based on actual needs, which is not limited in here.

As shown in FIG. 4 and FIG. 8, in one embodiment of the present disclosure, the infrared imaging unit 10 further includes a circuit board assembly. The circuit board assembly may be disposed on the side of the heat insulation assembly away from the infrared detector 106.

In this embodiment, the infrared imaging unit 10 includes an infrared detector 106, a circuit board assembly, and a heat insulation assembly, where the infrared detector 106 and the circuit board assembly may be respectively disposed on both sides of the heat insulation assembly. That is, the heat insulation assembly can separate the infrared detector 106 from the circuit board assembly. The heat insulation assembly can block the heat conduction and heat radiation of the circuit board assembly to the infrared detector 106, thereby reducing the influence of the heat generated by the circuit board assembly on the accuracy of the temperature measured by the infrared detector 106. Since the circuit board assembly is the main heating component in the infrared imaging unit 10, by blocking the heat conduction and heat radiation of the circuit board assembly to the infrared detector 106, the temperature measured by the infrared detector 106 can be closer to the temperature of the measured object.

In one embodiment of the present disclosure, the imaging device 1 may further include a temperature measuring device assembly disposed on the visible light imaging unit 20 and/or the infrared imaging unit 10. The temperature measuring device assembly can be used to measure the internal temperature and/or the external environment temperature of the imaging device 1.

In this embodiment, by arranging the temperature measuring device assembly on the visible light imaging unit 20 and/or the infrared imaging unit 10, the internal temperature and/or the external environment temperature of the imaging device 1 can be measured. That is, the interference temperature of the infrared detector 106 from the internal and/or external environment of the imaging device 1 can be obtained in real time through the temperature measuring device assembly, thereby reducing the influence of the interference temperature on the accuracy of the temperature measured by the infrared detector 106, such that the temperature measured by the infrared detector 106 can be closer to the temperature of the measured object.

As shown in FIG. 4 and FIG. 8, in one embodiment of the present disclosure, the circuit board assembly may include a main circuit board 110 and a signal processing circuit board 112. The heat insulation assembly may include a first heat insulator 108, which may be disposed between the infrared detector 106 and the signal processing circuit board 112; and a second heat insulator 114, which may be disposed between the main circuit board 110 and the signal processing circuit board 112.

In this embodiment, the circuit board assembly may include a main circuit board 110 and a signal processing circuit board 112, and the heat insulation assembly may include a first heat insulator 108 and a second heat insulator 114. In some embodiments, the infrared detector 106 and the first heat insulator 108 may be respectively disposed on both sides of the first heat insulator 108. That is, the first heat insulator 108 may isolate the infrared detector 106 from the signal processing circuit board 112, and the first heat insulator 108 may block the heat conduction and heat radiation from the signal processing circuit board 112 to the infrared detector 106. Further, the second heat insulator 114 may be disposed between the main circuit board 110 and the signal processing circuit board 112. The second heat insulator 114 may block the heat conduction and heat radiation from the main circuit board 110 to the signal processing circuit board 112 and the infrared detector 106, thereby reducing the influence of the heat generated by the main circuit board 110 on the accuracy of the temperature measured by the infrared detector 106, such that the temperature measured by the infrared detector 106 can be closer to the temperature of the measured object. Specifically, the signal processing circuit board 112 may be mounted on the first heat insulator 108 by screws. The second heat insulator 114 may be disposed between the main circuit board 110 and the signal processing circuit board 112, and screws may pass through the main circuit board 110, the second heat insulator 114, and the first heat insulator 108, and mount these parts on the middle frame 104. An anti-vibration pad may be disposed under the screw head of the screw to buffer the residual stress on the signal processing circuit board 112 and the main circuit board 110 due to the mechanical connection. The anti-vibration pad may be a rubber ring 138.

In some embodiments, the first heat insulator 108 may be a plastic first heat insulator 108. The plastic material is easy to process and shape, and the plastic material has good heat insulation performance.

As shown in FIG. 4 and FIG. 8, in one embodiment of the present disclosure, the first heat insulator 108 is configured as a cavity structure with an opening at one end. The circuit board assembly is connected to the opening end of the first heat insulator 108, and is sealed at the opening to form a heat insulating cavity with the first heat insulator 108.

In this embodiment, the first heat insulator 108 is constructed as a cavity structure with an opening at one end, and the circuit board assembly is sealed at the opening to form a heat insulating cavity with the first heat insulator 108. By forming a hollow heat insulating cavity, the low thermal conductivity of the air in the heat insulating cavity can be used to further isolate the heat conduction and heat radiation of the circuit board assembly to the infrared detector 106, thereby reducing the influence of the heat generated by the circuit board assembly on the accuracy of the temperature measured by the infrared detector 106, such that the temperature measured by the infrared detector 106 can be closer to the temperature of the measured object. Further, the thickness of the heat insulating cavity may be greater than or equal to 5 mm. That is, the distance between the circuit board assembly and the cavity bottom wall of the heat insulating cavity may be greater than or equal to 5 mm, such that a better heat insulation effected can be achieved.

As shown in FIG. 4 and FIG. 8, in one embodiment of the present disclosure, the infrared imaging unit 10 further includes a middle frame 104 disposed on the side of the infrared detector 106 facing the heat insulation assembly; a heat conducting element 116 disposed between the middle frame 104 and the infrared detector 106. One side of the infrared detector 106 may be attached to the heat conducting element 116.

In this embodiment, the infrared imaging unit 10 further includes a middle frame 104 and a heat conducting element 116 disposed between the middle frame 104 and the infrared detector 106. One side of the infrared detector 106 may be attached to the heat conducting element 116, such that the heat on the infrared detector 106 can be transferred to the middle frame 104 through the heat conducting element 116, thereby reducing the influence of the heat generated by the infrared detector 106 on its measurement accuracy. Further, the material of the middle frame 104 may be aluminum alloy. Aluminum alloy has good thermal conductivity, which is convenient for dissipating heat into the air through the middle frame 104. Further, the heat conducting element 116 may be a heat conductive plate or a heat conductive pad.

As shown in FIG. 3, FIG. 4, FIG. 7, and FIG. 8, in one embodiment of the present disclosure, the infrared imaging unit 10 further includes a front housing 118 connected to the middle frame 104, and a front housing heat conducting part 120 connected to the front housing 118. The front housing heat conducting part 120 may be disposed along the circumferential direction of the front housing 118 and extend outward, and the infrared imaging unit lens 102 may abut against the middle frame 104.

In this embodiment, the infrared imaging unit 10 further includes a front housing 118 connected to the middle frame 104. The front housing 118 and the middle frame 104 may jointly define an installation cavity for installing other components. However, since the front housing 118 and the middle frame 104 are close together, a part of the heat on the middle frame 104 will inevitably be conducted to the front housing 118, causing the temperature of the parts assembled with the front housing 118 to rise, which will interfere with the measurement accuracy of the infrared detector 106. By arranging a circle of front housing heat conducting part 120 extending outward along the circumference of the front housing 118, that is, a circle of heat conducting edges designed on the front housing 118, and abutting the front housing heat conducting part 120 against the middle frame 104, the effective heat conduction cross-sectional area of the front housing 118 and the middle frame 104 can be increased, the heat of the front housing 118 and the first heat insulator 108 can be uniform, and the actual temperature difference may not exceed 1° C. in this way, the interference of the temperature of the front housing 118 and the middle frame 104 to the infrared detector 106 can be considered as uniform.

As shown in FIG. 3, FIG. 4, FIG. 7, and FIG. 8, in one embodiment of the present disclosure, the infrared imaging unit 10 further includes a middle frame heat conducting part 122 connected to the middle frame 104. The middle frame heat conducting part 122 may be disposed along the circumferential direction of the middle frame 104 and may extend outward. The middle frame heat conducting part 122 may abut against the front housing heat conducting part 120.

In this embodiment, the middle frame heat conducting part 122 may also be disposed in the circumferential direction of the middle frame 104. Specifically, a circle of middle frame heat conducting part 122 extending outward may be disposed along the circumferential direction of the middle frame 104, that is, a circle of heat conducting edges may be designed on the middle frame 104, and the middle frame heat conducting part 122 may be arranged to abut against the middle frame heat conducting part 122. In this way, the effective heat conduction cross-sectional area of the front housing 118 and the middle frame 104 can be further increased, which further makes the heat of the front housing 118 and the middle frame 104 uniform.

As shown in FIG. 4, the temperature measuring device assembly includes a first temperature sensor 30 disposed in the front housing 118. The first temperature sensor 30 can be used to measure the interference temperature inside the infrared imaging unit 10 to the infrared detector 106.

In this embodiment, since the heat of the front housing 118 and the middle frame 104 is uniform, the actual temperature difference may not exceed 1° C., that is, the interference of the temperature of the front housing 118 and the middle frame 104 to the infrared detector 106 can be considered as uniform. By arranging the first temperature sensor 30 in the front housing 118, the interference temperature of the front housing 118, the middle frame 104, and the components mounted inside the front housing 118 and the middle frame 104 on the infrared detector 106 can be obtained in real time. That is, the temperature measured by the first temperature sensor 30 can be the interference temperature of the infrared imaging unit 10 to the infrared detector 106.

It can be understood that after the imaging device 1 starts to work, some parts inside the imaging device 1 will generate heat, causing the temperature of itself and the surrounding parts to rise. This part of the increased temperature will radiate energy outward in the form of infrared radiation, which will affect the temperature measurement accuracy of the infrared detector 106. Since the infrared imaging unit 10 is disposed in the housing 40, in the temperature obtained by the infrared detector 106, the interference temperature inside the infrared imaging unit 10 to the infrared detector 106 and the temperature inside the housing 40 of the imaging device 1 can affect the measurement accuracy of the infrared detector 106. In the imaging device 1 provided by the present disclosure, by using the first temperature sensor 30 in the front housing 118, the temperature measured by the first temperature sensor 30 can be the interference temperature inside the infrared imaging unit 10 to the infrared detector 106. By subtracting the temperature measured by the first temperature sensor 30 form the temperature measured by the infrared detector 106, the interference temperature inside the infrared imaging unit 10 to the infrared detector 106 can be eliminated, and the measurement accuracy of the infrared detector 106 can be improved.

As shown in FIG. 2, FIG. 5, and FIG. 6, in one embodiment of the present disclosure, the imaging device 1 further includes a housing 40. The visible light imaging unit 20 and the infrared imaging unit 10 may be disposed in the housing 40. The temperature measuring device assembly includes a second temperature sensor 50. The second temperature sensor 50 can be disposed in the housing 40, and the second temperature sensor 50 can be used to measure the interference temperature of the imaging device 1 to the infrared imaging unit 10.

In this embodiment, the imaging device 1 further includes a housing 40, and the temperature measuring device assembly includes a second temperature sensor 50. In some embodiments, the visible light imaging unit 20, the infrared imaging unit 10, and the second temperature sensor 50 may be all disposed in the housing 40, and the second temperature sensor 50 may detect the temperature in the housing 40, that is, the temperature inside the housing 40 of the imaging device 1.

It can be understood that after the imaging device 1 starts to work, some parts inside the imaging device 1 will generate heat, causing the temperature of itself and the surrounding parts to rise. This part of the increased temperature will radiate energy outward in the form of infrared radiation, which will affect the temperature measurement accuracy of the infrared detector 106. Since the infrared imaging unit 10 is disposed in the housing 40, in the temperature obtained by the infrared detector 106, the interference temperature inside the infrared imaging unit 10 to the infrared detector 106 and the temperature inside the housing 40 of the imaging device 1 can affect the measurement accuracy of the infrared detector 106. In the imaging device 1 provided by the present disclosure, by using the second temperature sensor 40 in the housing 40, the second temperature sensor 50 can detect the temperature in the housing 40, that is, the temperature inside the housing 40 of the imaging device 1. On the basis of the temperature measured by the infrared detector 106, the temperature measured by the second temperature sensor 50 can be subtracted to eliminate the interference of the internal temperature of the imaging device 1 on the infrared detector 106 and improve the measurement accuracy of the infrared detector 106.

As shown in FIG. 5, in one embodiment of the present disclosure, there is a gap between the front housing 118 and the housing 40.

In this embodiment, there is a gap between the front housing 118 of the infrared imaging unit 10 and the housing 40. That is, the front housing 118 is not directly attached to the housing 40. On one hand, the heat on the housing 40 can be prevented from being transferred to the front housing 118 to eliminate the interference of the temperature of the housing 40 on the infrared detector 106 as much as possible, and to improve the measurement accuracy of the infrared detector 106. On the other hand, the gap also makes the heat dissipation of the front housing 118 faster, such that the temperature measurement of the infrared detector 106 positioned in the front housing 118 can be more accurate.

As shown in FIG. 4 and FIG. 6, in one embodiment of the present disclosure, the imaging device 1 further includes an air inlet disposed on the housing 40. The air inlet can communicate with the outside of the housing 40 and the inside of the housing 40. The temperature measuring device assembly includes a third temperature sensor 60, which may be disposed in the housing 40 and positioned at the air inlet.

In this embodiment, the housing 40 further includes an air inlet connecting the inside of the housing 40 and the outside of the housing 40, and the third temperature sensor 60 is disposed at the air inlet. The temperature measured by the third temperature sensor 60 can be the temperature outside the housing 40, that is, the ambient temperature of the imaging device 1.

It can be understood that the imaging or temperature measurement of the infrared imaging unit 10 mainly relies on its internal infrared detector 106 to obtain the infrared radiation of the object, and after processing, the temperature of the to-be-measured object can be obtained. The temperature measurement accuracy of the infrared detector 106 can be affected by the ambient temperature. In the imaging device 1 provided by the present disclosure, by disposed the third temperature sensor 60 at the air inlet of the housing 40, the third temperature sensor 60 can detect the ambient temperature of the imaging device 1. On the basis of the temperature measured by the infrared detector 106, the temperature measured by the third temperature sensor 60 can be subtracted to eliminate the interference of the ambient temperature of the imaging device 1 on the infrared detector 106 and improve the measurement accuracy of the infrared detector 106.

As shown in FIG. 4, in one embodiment of the present disclosure, the infrared imaging unit 10 further includes a first sealing ring 124 disposed on the front housing 118. The infrared imaging unit lens 102 may include threads, and the infrared imaging unit lens 102 may be assembled on the front housing 118 through the threads. The infrared imaging unit 10 further includes a second sealing ring 126 disposed on the infrared imaging unit lens 102. The second sealing ring 126 can be used to seal the connection between the front housing 118 and the infrared imaging unit lens 102.

In this embodiment, the infrared imaging unit 10 further includes a first sealing ring 124 disposed on the front housing 118, and the first sealing ring 124 can be used to seal the connection between the front housing 118 and the housing 40 to provide waterproof performance of the imaging device 1. The infrared imaging unit lens 102 can be arranged with threads for assembling with the front housing 118, and the second sealing ring 126 can be disposed on the infrared imaging unit lens 102. The second sealing ring 126 can prevent water from entering the infrared imaging unit lens 102, making it waterproof.

As shown in FIG. 4, in one embodiment of the present disclosure, the infrared imaging unit 10 further includes a detector circuit board 128 fixedly connected to the infrared detector 106, and connected to the middle frame 104; a detector cover 130 connected to the middle frame 104, the detector cover 130 being arranged to cover a part of the infrared detector 106; and a shutter 132 connected to the middle frame 104.

In this embodiment, the infrared imaging unit 10 further includes a detector circuit board 128, a detector cover 130, and a shutter 132. Further, after the infrared detector 106 is welded and connected to the detector circuit board 128, it may be installed on the middle frame 104 by screws 136. The detector cover 130 may be installed on the infrared detector 106 by screws 136. The detector cover 130 can play a role of shielding the non-sensing area of the infrared detector 106 to reduce the radiation interference of the internal parts of the infrared imaging unit 10 by the infrared detector 106. The shutter 132 may be installed on the middle frame 104 through a positioning post and a screw 136 provided thereon. The shutter 132 can be used to eliminate the integral drift of the temperature measured by the infrared detector 106.

As shown in FIG. 4, in one embodiment of the present disclosure, the infrared imaging unit 10 further includes a flexible circuit board 134 connected to the detector circuit board 128 and the signal processing circuit board 112 to realize the transmission of electrical signals.

In this embodiment, the infrared imaging unit 10 further includes a flexible circuit board 134 connecting the detector circuit board 128 and the signal processing circuit board 112. The flexible circuit board 134 can be used to realize the transmission of electrical signals between the detector circuit board 128 and the signal processing circuit board 112.

In one embodiment of the present disclosure, the imaging device 1 may be connected to the UAV through a gimbal.

In some embodiments, the UAV provided in the present disclosure may include the imaging device 1. On one hand, it can solve the problem that in the related technology, a UAV can only be equipped with one infrared camera, which causes the operator to only obtain the infrared image information of the measured object, but cannot obtain the visible light image information. As a result, the pilot of the UAV cannot obtain the surrounding environment of the UAV, which is not beneficial for controlling the flight of the UAV. Further, it can solve the problem that the observers cannot fully understand the situation of the measured object based on the infrared images alone. On the other hand, it can solve the problem that in the related technology, when a UAV is equipped with an infrared camera and a visible light camera at the same time, the UAV can be overloaded, which has a serious impact on the flight time of the flight. At the same time, the maintenance and use cost of the two cameras will be much higher. Before the UAV takes off, the state of the two cameras needs to be checked separately, which requires a long preparation time, and the response time is poor. Further, in the imaging device 1 provided in the present disclosure, the heat insulation assembly can block the heat conduction and heat radiation of the heating parts in the infrared imaging unit 10 to the infrared detector 106, thereby reducing the influence of the of the heat generated in the infrared imaging unit 10 on the accuracy of the temperature measured by the infrared detector 106, such that the temperature measured by the infrared detector 106 can be closer to the temperature of the measured object.

As shown in FIG. 1 to FIG. 8, consistent with the present disclosure, the UAV provided by the third aspect of the present disclosure includes an imaging device 1, and the imaging device 1 integrates an infrared imaging unit 10 and a visible light imaging unit 20. Through thermal design, and the design of the first temperature sensor 30, the second temperature sensor 50, and the third temperature sensor 60, corrections can be made on the basis of the temperature measured by the infrared detector 106, thereby improving the temperature measurement accuracy of the to-be-measured object, such that the imaging device 1 can provide clearer and more accurate results in temperature measurement and thermal imaging.

As shown in FIG. 1 to FIG. 8, a fourth aspect of the present disclosure provides a UAV. The UAV may include a body, a power device to provide power for the UAV, and an infrared imaging unit 10. The infrared imaging unit 10 may include an infrared detector 106 and a heat insulation assembly. The heat insulation assembly may be positioned on one side of the infrared detector 106. The heat insulation assembly may be used to isolate the transfer of heat in the infrared imaging unit 10 to the infrared detector 106.

The UAV provided in the present disclosure may include a body, a power device, and an infrared imaging unit 10.

The infrared imaging unit 10 provided in the present disclosure includes an infrared detector 106 and a heat insulation assembly. The heat insulation assembly may be disposed on one side of the infrared detector 106, such that the heat insulation assembly can isolate the heat in the infrared detector 106 from transferring to the infrared detector 106. Specifically, the heat insulation assembly can block the heat conduction and heat radiation of the heating parts in the infrared imaging unit 10 to the infrared detector 106, and reduce the influence of the heat in the infrared imaging unit 10 on the accuracy of the temperature measured by the infrared detector 106, such that the temperature measured by the infrared detector 106 can be closer to the temperature of the measured object.

As shown in FIG. 4 and FIG. 8, in one embodiment of the present disclosure, the infrared imaging unit 10 further includes a circuit board assembly, which is disposed on one side of the heat insulation assembly away from the infrared detector 106.

In this embodiment, the infrared imaging unit 10 includes a circuit board assembly, and infrared detector 106, and a heat insulation assembly. The circuit board assembly is disposed on the side of the heat insulation assembly away from the infrared detector 106. That is, the infrared detector 106 and the circuit board assembly are respectively disposed on both sides of the heat insulation assembly. That is, the heat insulation assembly can isolate the infrared detector 106 and the circuit board assembly. The heat insulation assembly can block the heat conduction and heat radiation of the circuit board assembly to the infrared detector 106, thereby reducing the influence of the heat generated by the circuit board assembly on the accuracy of the temperature measured by the infrared detector 106. Since the circuit board assembly is the main heating component in the infrared imaging unit 10, by blocking the heat conduction and heat radiation of the circuit board assembly to the infrared detector 106, the temperature measured by the infrared detector 106 can be closer to the temperature of the measured object.

As shown in FIG. 4 and FIG. 8, in one embodiment of the present disclosure, the circuit board assembly includes a main circuit board 110 and a signal processing circuit board 112. The heat insulation assembly includes a first heat insulator 108, which may be disposed between the infrared detector 106 and the signal processing circuit board 112.

In this embodiment, the circuit board assembly includes a main circuit board 110 and a signal processing circuit board 112, and the heat insulation assembly includes a first heat insulator 108. In some embodiments, the infrared detector 106 and the first heat insulator 108 may be respectively disposed on both sides of the first heat insulator 108. That is, the first heat insulator 108 may isolate the infrared detector 106 from the signal processing circuit board 112, and the first heat insulator 108 may block the heat conduction and heat radiation from the signal processing circuit board 112 to the infrared detector 106.

As shown in FIG. 4 and FIG. 8, in one embodiment of the present disclosure, the circuit board assembly further includes a second heat insulator 114, which may be disposed between the main circuit board 110 and the signal processing circuit board 112.

In this embodiment, the second heat insulator 114 is disposed between the main circuit board 110 and the signal processing circuit board 112. The second heat insulator 114 may block the heat conduction and heat radiation from the main circuit board 110 to the signal processing circuit board 112 and the infrared detector 106, thereby reducing the influence of the heat generated by the main circuit board 110 on the accuracy of the temperature measured by the infrared detector 106, such that the temperature measured by the infrared detector 106 can be closer to the temperature of the measured object.

Specifically, the signal processing circuit board 112 may be mounted on the first heat insulator 108 by screws. The second heat insulator 114 may be disposed between the main circuit board 110 and the signal processing circuit board 112, and screws may pass through the main circuit board 110, the second heat insulator 114, and the first heat insulator 108, and mount these parts on the middle frame 104. An anti-vibration pad may be disposed under the screw head of the screw to buffer the residual stress on the signal processing circuit board 112 and the main circuit board 110 due to the mechanical connection. The anti-vibration pad may be a rubber ring 138.

In some embodiments, the first heat insulator 108 may be a plastic first heat insulator 108. The plastic material is easy to process and shape, and the plastic material has good heat insulation performance.

As shown in FIG. 4 and FIG. 8, in one embodiment of the present disclosure, the first heat insulator 108 is configured as a cavity structure with an opening at one end, and a through hole is opened on the other end of the first heat insulator 108 opposite to the end with the opening.

In this embodiment, the first heat insulator 108 is configured as a cavity structure with an opening at one end to take advantage of the low thermal conductivity of the air in the cavity structure to further isolation the heat conduction and heat radiation of the circuit board assembly to the infrared detector 106, thereby reducing the influence of the heat generated by the circuit board assembly on the accuracy of the temperature measured by the infrared detector 106, such that the temperature measured by the infrared detector 106 can be closer to the temperature of the measured object. Further, a through hole can be opened on the other end of the first heat insulator 108 opposite to the end with the opening. The through hole can be used for the passage of a flexible circuit board 134, such that the components disposed on both sides of the first heat insulator 108 can be connected through the flexible circuit board 134.

As shown in FIG. 4 and FIG. 8, in one embodiment of the present disclosure, the circuit board assembly is connected to at least one end of the first heat insulator 108 having an opening.

As shown in FIG. 4 and FIG. 8, in one embodiment of the present disclosure, the circuit board assembly is sealed at the opening to form a heat insulating cavity with the first heat insulator 108.

In this embodiment, the circuit board assembly is connected to at least one end of the first heat insulator 108 having an opening, and the circuit board assembly is sealed at the opening to form a heat insulating cavity with the first heat insulator 108. By forming a hollow heat insulating cavity, the low thermal conductivity of the air in the heat insulating cavity can be used to further isolate the heat conduction and heat radiation of the circuit board assembly to the infrared detector 106, thereby reducing the influence of the heat generated by the circuit board assembly on the accuracy of the temperature measured by the infrared detector 106, such that the temperature measured by the infrared detector 106 can be closer to the temperature of the measured object.

As shown in FIG. 8, in some embodiments, the thickness of the heat insulating cavity may be greater than or equal to 5 mm. That is, the distance between the circuit board assembly and the cavity bottom wall of the heat insulating cavity may be greater than or equal to 5 mm, such that a better heat insulation effected can be achieved.

As shown in FIG. 8, in one embodiment of the present disclosure, the infrared imaging unit 10 further includes a middle frame 104 and a front housing 118. When the front housing 118 is connected to the middle frame 104, the inside of the middle frame 104 and the front housing 118 may form an installation cavity.

In this embodiment, the infrared imaging unit 10 further includes a middle frame 104 and a front housing 118. When the front housing 118 is connected to the middle frame 104, the inside of the middle frame 104 and the front housing 118 may form an installation cavity. The installation cavity may be used to install other components, thereby protecting the components in the installation cavity.

As shown in FIG. 4 and FIG. 8, in one embodiment of the present disclosure, when the front housing 118 and the middle frame 104 are connected, the front housing 118 and the middle frame 104 may abut against each other in a circumferential direction.

In this embodiment, by limiting the connection between the front housing 118 and the middle frame 104, the front housing 118 and the middle frame 104 may abut against each other in the circumferential direction, such that the heat transfer between the front housing 118 and the middle frame 104 can be uniform and fast, and the temperature measured by the infrared detector 106 inside the installation cavity can be more accurate.

As shown in FIG. 4 and FIG. 8, in one embodiment of the present disclosure, the heat insulation assembly is disposed outside the installation cavity, and the infrared detector 106 is disposed inside the installation cavity.

In this embodiment, the infrared detector 106 is disposed inside the installation cavity, and the heat insulation assembly is disposed outside the installation cavity. Since the circuit board assembly is disposed on the side of the heat insulation assembly away from the infrared detector 106, that is, the circuit board assembly is also disposed outside the installation cavity, the infrared detector 106 can be better separated from the circuit board assembly. In this way, the influence of the heat generated by the circuit board assembly on the accuracy of the temperature measured by the infrared detector 106 can be more effectively reduced, thereby making the temperature measured by the infrared detector 106 closer to the temperature of the measured object.

As shown in FIG. 4, in one embodiment of the present disclosure, the infrared imaging unit 10 further includes a heat conducting element 116, which may be disposed between the middle frame 104 and the infrared detector 106. One side of the infrared detector 106 may be attached to the heat conducting element 116. The middle frame 104 may be disposed on the side of the infrared detector 106 facing the heat insulation assembly.

In this embodiment, the infrared imaging unit 10 further includes a heat conducting element 116 disposed between the middle frame 104 and the infrared detector 106. One side of the infrared detector 106 may be attached to the heat conducting element 116, such that the heat on the infrared detector 106 can be transferred to the middle frame 104 through the heat conducting element 116, thereby reducing the influence of the heat generated by the infrared detector 106 on its measurement accuracy. Further, the material of the middle frame 104 may be aluminum alloy. Aluminum alloy has good thermal conductivity, which is convenient for dissipating heat into the air through the middle frame 104. Further, the heat conducting element 116 may be a heat conductive plate or a heat conductive pad.

As shown in FIG. 3, FIG. 4, FIG. 7, and FIG. 8, in one embodiment of the present disclosure, the infrared imaging unit 10 further includes a front housing heat conducting part 120 connected to the front housing 118. The front housing heat conducting part 120 may be disposed along the circumference of the front housing 118 and may extend outward. The front housing heat conducting part 120 may abut against the middle frame 104.

In this embodiment, the front housing 118 of the infrared imaging unit 10 and the infrared imaging unit 104 may jointly define an installation cavity for installing other components. However, since the front housing 118 and the middle frame 104 are close together, a part of the heat on the middle frame 104 will inevitably be conducted to the front housing 118, causing the temperature of the parts assembled with the front housing 118 to rise, which will interfere with the measurement accuracy of the infrared detector 106. By arranging a circle of front housing heat conducting part 120 extending outward along the circumference of the front housing 118, that is, a circle of heat conducting edges designed on the front housing 118, and abutting the front housing heat conducting part 120 against the middle frame 104, the effective heat conduction cross-sectional area of the front housing 118 and the middle frame 104 can be increased, the heat of the front housing 118 and the first heat insulator 108 can be uniform, and the actual temperature difference may not exceed 1° C. in this way, the interference of the temperature of the front housing 118 and the middle frame 104 to the infrared detector 106 can be considered as uniform.

As shown in FIG. 3, FIG. 4, FIG. 7, and FIG. 8, in one embodiment of the present disclosure, the infrared imaging unit 10 further includes a middle frame heat conducting part 122 connected to the middle frame 104. The middle frame heat conducting part 122 may be disposed along the circumferential direction of the middle frame 104 and may extend outward. The middle frame heat conducting part 122 may abut against the front housing heat conducting part 120.

In this embodiment, the middle frame heat conducting part 122 may also be disposed in the circumferential direction of the middle frame 104. Specifically, a circle of middle frame heat conducting part 122 extending outward may be disposed along the circumferential direction of the middle frame 104, that is, a circle of heat conducting edges may be designed on the middle frame 104, and the middle frame heat conducting part 122 may be arranged to abut against the middle frame heat conducting part 122. In this way, the effective heat conduction cross-sectional area of the front housing 118 and the middle frame 104 can be further increased, which further makes the heat of the front housing 118 and the middle frame 104 uniform.

As shown in FIG. 4, in one embodiment of the present disclosure, the infrared imaging unit 10 further includes a first temperature sensor 30 disposed in the front housing 118. The first temperature sensor 30 can be used to measure the interference temperature inside the infrared imaging unit 10 to the infrared detector 106.

In this embodiment, since the heat of the front housing 118 and the middle frame 104 is uniform, the actual temperature difference may not exceed 1° C., that is, the interference of the temperature of the front housing 118 and the middle frame 104 to the infrared detector 106 can be considered as uniform. By arranging the first temperature sensor 30 in the front housing 118, the interference temperature of the front housing 118, the middle frame 104, and the components mounted inside the front housing 118 and the middle frame 104 on the infrared detector 106 can be obtained in real time. That is, the temperature measured by the first temperature sensor 30 can be the interference temperature of the infrared imaging unit 10 to the infrared detector 106.

It can be understood that after the infrared imaging unit 10 starts to work, some parts inside the infrared imaging unit 10 will generate heat, causing the temperature of itself and the surrounding parts to rise. This part of the increased temperature will radiate energy outward in the form of infrared radiation, which will affect the temperature measurement accuracy of the infrared detector 106. Since the infrared imaging unit 10 is disposed in the housing 40, in the temperature obtained by the infrared detector 106, the interference temperature inside the infrared imaging unit 10 to the infrared detector 106 and the temperature inside the housing 40 of the imaging device 1 can affect the measurement accuracy of the infrared detector 106. By arranging the first temperature sensor 30 in the front housing 118, the temperature measured by the first temperature sensor 30 can be the interference temperature inside the infrared imaging unit 10 to the infrared detector 106. By subtracting the temperature measured by the first temperature sensor 30 form the temperature measured by the infrared detector 106, the interference temperature inside the infrared imaging unit 10 to the infrared detector 106 can be eliminated, and the measurement accuracy of the infrared detector 106 can be improved.

As shown in FIG. 1, FIG. 2, FIG. 3, FIG. 4, and FIG. 6, in one embodiment of the present disclosure, the infrared imaging unit 10 further includes an infrared imaging unit lens 102, and an optical element installation position disposed on the front housing 118. The infrared imaging unit lens 102 of the infrared imaging unit may be installed in the optical element installation position.

In this embodiment, by arranging the optical element installation position on the front housing 118, the infrared imaging unit lens 102 can be installed on the front housing 118 and positioned at the optical element installation position. The optical element installation position can facilitate the installation of the infrared imaging unit lens 102. Further, the infrared detector 106 may be coaxially disposed with the infrared imaging unit lens 102.

As shown in FIG. 4, in one embodiment of the present disclosure, the infrared imaging unit 10 further includes a first sealing ring 124 disposed on the front housing 118. The infrared imaging unit lens 102 may include threads, and the infrared imaging unit lens 102 may be assembled on the front housing 118 through the threads. The infrared imaging unit 10 further includes a second sealing ring 126 disposed on the infrared imaging unit lens 102. The second sealing ring 126 can be used to seal the connection between the front housing 118 and the infrared imaging unit lens 102.

In this embodiment, the infrared imaging unit 10 further includes a first sealing ring 124 disposed on the front housing 118, and the first sealing ring 124 can be used to seal the connection between the front housing 118 and the housing 40 to provide waterproof performance of the imaging device 1. The infrared imaging unit lens 102 can be arranged with threads for assembling with the front housing 118, and the second sealing ring 126 can be disposed on the infrared imaging unit lens 102. The second sealing ring 126 can prevent water from entering the infrared imaging unit lens 102, making it waterproof.

As shown in FIG. 4, in one embodiment of the present disclosure, the infrared imaging unit 10 further includes a detector circuit board 128 fixedly connected to the infrared detector 106, and connected to the middle frame 104; a detector cover 130 connected to the middle frame 104, the detector cover 130 being arranged to cover a part of the infrared detector 106; and a shutter 132 connected to the middle frame 104.

In this embodiment, the infrared imaging unit 10 further includes a detector circuit board 128, a detector cover 130, and a shutter 132. Further, after the infrared detector 106 is welded and connected to the detector circuit board 128, it may be installed on the middle frame 104 by screws 136. The detector cover 130 may be installed on the infrared detector 106 by screws 136. The detector cover 130 can play a role of shielding the non-sensing area of the infrared detector 106 to reduce the radiation interference of the internal parts of the infrared imaging unit 10 by the infrared detector 106. The shutter 132 may be installed on the middle frame 104 through a positioning post and a screw 136 provided thereon. The shutter 132 can be used to eliminate the integral drift of the temperature measured by the infrared detector 106.

As shown in FIG. 4, in one embodiment of the present disclosure, the infrared imaging unit 10 further includes a flexible circuit board 134 connected to the detector circuit board 128 and the signal processing circuit board 112 to realize the transmission of electrical signals.

In this embodiment, the infrared imaging unit 10 further includes a flexible circuit board 134 connecting the detector circuit board 128 and the signal processing circuit board 112. The flexible circuit board 134 can be used to realize the transmission of electrical signals between the detector circuit board 128 and the signal processing circuit board 112.

As shown in FIG. 4, in one embodiment of the present disclosure, the heat conducting element 116, the detector circuit board 128, the detector cover 130, the shutter 132, and the flexible circuit board 134 can be disposed in the installation cavity.

In this embodiment, by disposing the heat conducting element 116, the detector circuit board 128, the detector cover 130, the shutter 132, the flexible circuit board 134, the infrared detector 106, and other components in the installation cavity, the installation cavity formed by the front housing 118 and the middle frame 104 can protect the aforementioned components.

In one embodiment of the present disclosure, the infrared imaging unit 10 may be connected to the UAV through a gimbal.

In some embodiments, the UAV provided in the present disclosure can include the infrared imaging unit 10 provided in the present disclosure. The heat insulation assembly can block the heat conduction and heat radiation of the heating parts in the infrared imaging unit 10 to the infrared detector 106, thereby reducing the influence of the of the heat generated in the infrared imaging unit 10 on the accuracy of the temperature measured by the infrared detector 106, such that the temperature measured by the infrared detector 106 can be closer to the temperature of the measured object.

In the description of this specification, the term “plurality” indicates two or more, unless otherwise expressly defined. The orientation or location relationship indicated by the terms “above,” “below,” etc., is an orientation or location relationship based on what is shown in the drawing, is only for the convenience of describing the embodiments of the present disclosure and for the simplicity of the descriptions, and does not indicate or imply that the device or component referred to must include a specific orientation, or be configured or operated with a specific orientation, and therefore cannot be understood as limiting the embodiments of the present disclosure. The terms “mounted”, “connected”, “connection”, “fixed”, and the like should be understood in a broad sense. For example, “connection” may be a fixed connection, a detachable connection, or an integrated connection; and “connected” may be “directly connected” or may be “indirectly connected” via an intermediate medium. A person of ordinary skill in the art would understand specific meanings of these terms in this application based on specific situations.

In the description of this specification, the description of the terms “an embodiment”, “some embodiments”, “specific embodiments”, and the like means that specific features, structures, materials, or characteristics described with reference to the embodiment(s) or example(s) are included in at least one embodiment or example of this application. In this specification, a schematic representation of the foregoing terms does not necessarily refer to a same embodiment or a same example. In addition, the described specific features, structures, materials, or characteristics may be combined in one or more embodiments or examples in an appropriate manner.

The foregoing descriptions are only preferred embodiments of this application, and not intended to limit this application. For a person skilled in the art, this application may have various changes and variations. Any modifications, equivalent replacements, improvements, and the like made within the spirit and principle of this application shall fall within the scope of protection of this application.

What is claimed is:

1. An infrared imaging unit comprising:
an infrared detector;
a heat insulation assembly, the heat insulation assembly being disposed on one side of the infrared detector, the heat insulation assembly being used to isolate a heat transfer in the infrared imaging unit to the infrared detector.

2. The infrared imaging unit of claim 1 further comprising:
a circuit board assembly, the circuit board assembly being disposed on a side of the heat insulation assembly away from the infrared detector.

3. The infrared imaging unit of claim 2, wherein:
the circuit board assembly includes a main circuit board and a signal processing circuit board; and
the heat insulation assembly includes a first heat insulator, the first heat insulator being disposed between the infrared detector and the signal processing circuit board.

4. The infrared imaging unit of claim 3, wherein:
the heat insulation assembly further includes a second heat insulator disposed between the main circuit board and the signal processing circuit board.

5. The infrared imaging unit of claim 3, wherein:
the first heat insulator is configured as a cavity structure with an opening at one end.

6. The infrared imaging unit of claim 5, wherein:
a through hole is placed on the other end of the first heat insulator opposite to the end with the opening.

7. The infrared imaging unit of claim 5, wherein:
the circuit board assembly is connected to the at least one end of the first heat insulator having the opening.

8. The infrared imaging unit of claim 5, wherein:
the circuit board assembly is sealed at an opening to form a heat insulating cavity with the first heat insulator.

9. The infrared imaging unit of claim 3 further comprising:
a middle frame; and
a front housing, the middle frame and inside of the front housing forming an installation cavity when the front housing is connected to the middle frame.

10. The infrared imaging unit of claim 9, wherein:
the front housing abuts against the middle frame in a circumferential direction when the front housing is connected to the middle frame.

11. The infrared imaging unit of claim 9, wherein:
the heat insulation assembly is disposed outside the installation cavity, and the infrared detector is disposed inside the installation cavity.

12. The infrared imaging unit of claim 9 further comprising:
a heat conducting element disposed between the middle frame and the infrared detector, one side of the infrared detector being attached to the heat conducting element, wherein
the middle frame is disposed on the side of the infrared detector facing the heat conducting element.

13. The infrared imaging unit of claim 9 further comprising:
a front housing heat conducting part connected to the front housing, the front housing heat conducting part being disposed along a circumference of the front housing and extend outward, the front housing heat conducting part being configured to abut against the middle frame.

14. The infrared imaging unit of claim 13 further comprising:
a middle frame heat conducting part connected to the middle frame, the middle frame heat conducting part being disposed along a circumference of the middle frame and extend outward, the middle frame heat conducting part being configured to abut against the front housing heat conducting part.

15. The infrared imaging unit of claim 13 further comprising:
a first temperature sensor disposed on the front housing, the first temperature sensor being configured to measure an interference temperature of the infrared detector inside the infrared imaging unit.

16. The infrared imaging unit of claim 13 further comprising:
an infrared imaging unit lens; and
an optical element installation position disposed on the front housing, the infrared imaging unit lens being installed in the optical element installation position.

17. The infrared imaging unit of claim 13 further comprising:
a first sealing ring disposed on the front housing, the infrared imaging unit lens having threads disposed thereon, the infrared imaging unit lens being assembled on the front housing through the threads; and
a second sealing ring disposed on the infrared imaging unit lens, the second sealing ring being configured to seal a connection between the front housing and the infrared imaging unit lens.

18. The infrared imaging unit of claim 12 further comprising:
a detector circuit board fixedly connected with the infrared detector, and connected with the middle frame;
a detector cover connected to the middle frame, the detector cover covering a part of the infrared detector; and
a shutter connected to the middle frame.

19. An imaging device comprising:
a visible light imaging unit; and
an infrared imaging unit, an infrared imaging unit lens and a visible light imaging unit lens facing the same direction, the infrared imaging unit including:
an infrared detector; and
a heat insulation assembly, the heat insulation assembly being disposed on one side of the infrared detector, the heat insulation assembly being used to isolate a heat transfer in the imaging device to the infrared detector.

20. A UAV comprising:
a body;
a power device configured to provide power for the UAV; and
an imaging device, the imaging device including:
a visible light imaging unit; and
an infrared imaging unit, an infrared imaging unit lens and a visible light imaging unit lens facing the same direction, the infrared imaging unit including:
an infrared detector; and
a heat insulation assembly, the heat insulation assembly being disposed on one side of the infrared detector, the heat insulation assembly being used to isolate a heat transfer in the imaging device to the infrared detector.
